(19) United States
(12) Patent Application Publication
(10) Pub. No.: US 2025/0051569 A1
(43) Pub. Date: Feb. 13, 2025

(54) POLYAMIDE RESIN COMPOSITION AND MOLDED ARTICLE

(71) Applicant: ASAHI KASEI KABUSHIKI KAISHA, Tokyo (JP)

(72) Inventors: Teruaki SAKUMA, Tokyo (JP); Yasukazu SHIKANO, Tokyo (JP); Takaaki MIYOSHI, Tokyo (JP)

(73) Assignee: ASAHI KASEI KABUSHIKI KAISHA, Tokyo (JP)

(21) Appl. No.: 18/717,683

(22) PCT Filed: Feb. 15, 2023
(86) PCT No.: PCT/JP2023/005098

§ 371 Date: Jun. 7, 2024

(30) Foreign Application Priority Data
Feb. 18, 2022 (JP) 2022-023815

(51) Int. Cl. C08L 77/10; C08K 3/16; C08K 5/3447; C08K 5/3465; C08K 7/14

(52) U.S. Cl. CPC C08L 77/10; C08K 3/16; C08K 5/3447; C08K 5/3465; C08K 7/14; C08L 2205/025

(57) ABSTRACT

A polyamide resin composition according to the present invention is characterized by comprising 100 parts by mass of a polyamide resin (A), 0.005-0.3 parts by mass of a copper compound (B), and 10-250 parts by mass of glass fibers (C), and is characterized in that the percentage content of boron elements in the glass fibers (C) is 1 mass % or less with respect to the total mass of the glass fibers (C).

### TECHNICAL FIELD

The present invention relates to a polyamide resin composition and a molded article.

The present invention claims priority on the basis of Japanese Patent Application No. 2022-023815 filed in Japan on Feb. 18, 2022, the contents of which are incorporated herein by reference.

### BACKGROUND ART

A polyamide resin has excellent mechanical properties, thermal properties and oil resistance. Furthermore, a reinforced polyamide resin in which glass fibers are blended with a polyamide resin has greatly improved mechanical properties, heat resistance, chemical resistance, or the like, compared to an ordinary polyamide resin in which no glass fibers are blended therein. Polyamide resins and glass fiber-reinforced polyamide resins having such characteristics are used in various industrial fields.

Examples of the fields where polyamide resins and glass fiber-reinforced polyamide resins are used include materials of electronic equipment parts and automobile parts. Molded articles such as electronic equipment parts or automobile parts are required to be thinner, smaller, and lighter in terms of design and reliability. Furthermore, these parts are required to have improved mechanical properties. In order to meet this demand, parts of polyamide resins or reinforced polyamide resins are being used to replace conventional metal parts therewith and to reduce weight and streamline processes.

In particular, the heat aging resistance of polyamide resins are superior to that of other resins, so the polyamide resins are suitably used as materials of parts in high-temperature environments such as around automobile engines, motors, or batteries.

The term “heat aging resistance” refers to the property which easily maintains the strength of a molded article of a polyamide resin after being exposed to a high-temperature environment for a long time. In the case where the strength of a molded article after being exposed to a high-temperature environment (a molded article after heat aging) hardly decreases from the strength of a molded article before being exposed to the high-temperature environment, the heat aging resistance is evaluated as excellent.

In conventional automobiles having engines, the environmental temperature in an engine room is getting higher and higher as parts used in an automobile engine room are densified and the engine output increases. Therefore, a polyamide resin capable of maintaining excellent heat aging resistance for a long time at a level which significantly exceeds the conventional level is required to make it usable in an engine room.

Since surroundings of a motor and battery in an electric automobile are also in a high temperature environment, a polyamide resin capable of maintaining excellent heat aging resistance for a long time is required in a similar manner.

In a known technique for improving the heat aging resistance of a polyamide resin, a copper compound (such as a copper oxide, copper salt, or organic copper compound) and a halogen compound are added thereto. As the halogen compound, an iodine compound is generally added, and a technique of blending a polyamide resin with a copper compound, an iodine compound, and an aliphatic carboxylic acid derivative is known (see, for example, Patent Document 1).

### CITATION LIST

### Patent Literature

[Patent Document 1] Japanese Unexamined Patent Application Publication No. Hei 7-18176

### SUMMARY OF INVENTION

### Technical Problem

The heat aging resistance of the polyamide resin composition disclosed in PLT 1 is improved by including a copper compound therein. However, when a copper compound is contained in a composition, such as the polyamide resin composition of PLT 1, there is a problem in which the color of the composition tends to be changed depending on the water amount in the composition, such as exhibiting a pale pink color if the amount of water absorbed from the air is small, whilst exhibiting a pale green color if the amount of water absorbed from the air is large. Therefore, a novel polyamide resin composition that suppresses color change is required.

The present invention has been made in view of the above circumstances, and aims to provide a polyamide resin composition capable of suppressing discoloration due to moisture while maintaining mechanical properties and high heat aging resistance. In addition, the present invention aims to provide a molded article using such a polyamide resin composition as a material, the molded article being capable of suppressing discoloration due to moisture while maintaining mechanical properties and high heat aging resistance.

### Solution to Problem

The present inventors have made studies to solve the above-mentioned problems, thereby finding that a resin composition containing specific amounts of a polyamide resin, a copper compound, and glass fibers in which boron elements are defined can solve the above-mentioned problems, and thus the present invention has been completed.

The present invention encompasses the following aspects.

[1] A polyamide resin composition containing: 100 parts by mass of a polyamide resin (A); 0.005 parts by mass to 0.3 parts by mass of a copper compound (B); and 10 parts by mass to 250 parts by mass of glass fibers (C), characterized in that the amount of boron elements in the glass fibers (C) relative to the total mass of the glass fibers (C) is 1% by mass or less.

[2] The polyamide resin composition according to [1] mentioned above, wherein the polyamide resin (A) is at least one selected from the group consisting of the following polyamide and the following copolyamide, the polyamide is selected from the group consisting of polyamide 6, polyamide 46, polyamide 66, polyamide 610, polyamide 612, polyamide 4T, polyamide 6T, polyamide 61 and polyamide MXD6, and the copolyamide is a copolymer containing at least one selected from the group consisting of polyamide 6, polyamide 46, polyamide 66, polyamide 610, polyamide 612, polyamide 4T, polyamide 6T, polyamide 61 and polyamide MXD6 as a constituent.

[3] The polyamide resin composition according to [1] or [2] mentioned above, wherein the polyamide resin (A) contains: a main component polyamide (A-1); and at least one different polyamide (A-2).

[4] The polyamide resin composition according to [3] mentioned above, wherein the molecular weight of the different polyamide (A-2) is smaller than the molecular weight of the main component polyamide (A-1).

[5] The polyamide resin composition according to [3] or [4] mentioned above, wherein the amount of the different polyamide (A-2) relative to 100 parts by mass of the polyamide resin (A) is 0.01 parts by mass to 10 parts by mass.

[6] The polyamide resin composition according to any one of [1] to [5] mentioned above, further containing at least one selected from the group consisting of an alkali metal halide and an alkaline earth metal halide (D), wherein the molar ratio of the amount of the halide (D) and the amount of the copper compound (B) is 2/1 to 50/1.

[7] The polyamide resin composition according to any one of [1] to [6] mentioned above, wherein the molar ratio (Mg/Si) of magnesium (Mg) elements and silicon (Si) elements in the glass fibers (C) is 0.01 to 0.2.

[8] The polyamide resin composition according to any one of [1] to [7] mentioned above, wherein the amount of iron (Fe) elements in the glass fibers (C) relative to the total mass of the glass fibers (C) is 0.01% by mass to 2.0% by mass.

[9] The polyamide resin composition according to any one of [1] to [8] mentioned above, wherein the amount of sodium (Na) elements in the glass fibers (C) relative to the total mass of the glass fibers (C) is 0.1% by mass to 3.0% by mass.

[10] The polyamide resin composition according to any one of [1] to [9] mentioned above, further containing 0.01 parts by mass to 5 parts by mass of a coloring agent (E) relative to 100 parts by mass of the polyamide resin composition.

[11] The polyamide resin composition according to mentioned above, wherein the coloring agent (E) contains at least one selected from the group consisting of titanium oxide, zinc sulfide, zinc oxide, iron oxide and an organic dye.

[12] The polyamide resin composition according to mentioned above, wherein the coloring agent (E) contains at least one orange coloring agent.

[13] A molded article formed from the polyamide resin composition of any one of [1] to [10] mentioned above.

[14] A molded article formed from the polyamide resin composition of mentioned above.

[15] A molded article formed from the polyamide resin composition of mentioned above.

[16] The molded article according to any one of to mentioned above, wherein the molded article is an automobile part.

[17] A polyamide resin composition containing: 100 parts by mass of a polyamide resin (A); 0.005 parts by mass to 0.3 parts by mass of a copper compound (B); and 10 parts by mass to 60 parts by mass of glass fibers (C), wherein the polyamide resin composition has a tensile strength of 3.0 or more per part by mass of the glass fibers, the tensile strength being measured after heat aging by the following method:

(Tensile Strength after Heat Aging)
a molded piece of a multi-purpose test piece (type A) produced using the polyamide resin composition by a method conforming to ISO 3167 is heat aged for 1,000 hours at 200° C. in a hot air circulating oven; and
the test piece after heat aging is cooled at 23° C. for 24 hour or more, and then subjected to a tensile test at a tensile speed of 5 mm/min by a method conforming to ISO 527 to measure the tensile strength after heat aging (MPa).

### Advantageous Effects of Invention

The present invention makes it possible to provide a polyamide resin composition that can suppress discoloration due to moisture while maintaining mechanical properties and high heat aging resistance. Furthermore, the use of such a polyamide resin composition as a material makes it possible to provide a molded article capable of suppressing discoloration due to moisture while maintaining mechanical properties and high heat aging resistance.

### DESCRIPTION OF EMBODIMENTS

Hereinafter, an embodiment in which the present invention is carried out (hereinafter, describes as “the present embodiment”) will be explained in detail.

The following embodiment is an example that explains the present invention, and the present invention is not limited to the following embodiment, and various modifications can be made within the scope of the gist of the present invention to be carried out.

### <<Polyamide Resin>>

The polyamide resin composition according to the present embodiment includes a polyamide resin (A) (hereinafter, may be referred to as component (A)), a copper compound (B) (hereinafter, may be referred to as component (B)) and glass fibers (C) (hereinafter, may be referred to as component (C)). Furthermore, the polyamide resin composition may contain either or both of an alkali metal halide and an alkaline earth metal halide (D) (hereinafter, may be referred to as component (D)).

Regarding the polyamide resin composition according to the present embodiment, the mechanical properties, heat aging resistance, and discoloration due to moisture, which are problems, are measured and evaluated by the following methods.

### (Preparation of Test Piece)

The polyamide resin composition is pelletized, and the obtained pellets are used to prepare a molded piece of a multi-purpose test piece (type A) by a method conforming to ISO 3167.

### (Mechanical Properties)

The multi-purpose test piece is cut to prepare a test piece having a size of 80 mm×10 mm×4 mm. Next, the prepared test piece is subjected to a bending strength test at a test speed of 2 mm/min in accordance with ISO 178 to measure the bending strength (MPa).

Furthermore, the notched Charpy impact strength (KJ/m²) is measured using the prepared test piece in accordance with ISO 178.

### (Heat Aging Resistance)

The multi-purpose test piece is subjected to a tensile test at a tensile speed of 5 mm/min by a method conforming to ISO 527 to measure the tensile strength before heat aging.

In addition, the multipurpose test piece is heat aged in a hot air circulating oven at 200° C. for 1,000 hours. The multi-purpose test piece after heat aging is cooled at 23° C. for 24 hour or more, and then subjected to a tensile test at a tensile speed of 5 mm/min by a method conforming to ISO 527 to measure the tensile strength (MPa) after heat aging for 1,000 hours.

The retention ratio of the tensile strength after heat aging to the tensile strength before heat aging is determined.

### (Discoloration Due to Moisture)

The polyamide resin composition is pelletized, and the obtained pellets are used to produce a tabular plate molded piece (having a size of 60 mm×90 mm and a thickness of 3 mm) by carrying out an injection molding.

A tabular plate molded piece is left in a constant temperature and humidity room at a room temperature of 23° C. and a humidity of 50% for 50 hours and then subjected to a measurement of L* (luminance), a* (redness), and b* (yellowness) at the central portion of the molded piece in accordance with JIS-Z 8781.

Thereafter, the tabular plate molded piece is dried in a nitrogen atmosphere at 100° C. for 72 hours, and then the L*, a*, and b* at the central portion thereof are measured in the same manner as that before drying.

The color difference (ΔE*) from the color tone determined based on the following formula is defined as the color tone change.

ΔE*=√{(LS*−LB*)²+(aS*−aB*)²+(bS*−bB*)²}

LS*, aS*, bS*: L*, a*, b* of the molded piece after being left in the constant temperature and humidity room for 50 hours.

LB*, aB*, bB*: L*, a*, b* of the molded piece after drying for 72 hours in a nitrogen atmosphere.

### <Polyamide Resin (A)>

In the present specification, the term “polyamide resin” refers to a polymer compound having a —CO—NH— (amide) bond in the main chain thereof.

Although the component (A) is not limited to the following, examples thereof include polyamide resin obtained by ring-opening polymerization of lactam, polyamide resin obtained by self-condensation of ω-aminocarboxylic acid, polyamide resin obtained by condensation of diamine and dicarboxylic acid, and copolymers thereof.

One type of these polyamide resins may be used alone, or a mixture of at least two types thereof may be used.

The materials of the component (A) in the present embodiment will be described below.

Although the lactam used as a monomer of the polyamide resin is not limited to the following, examples thereof include pyrrolidone, caprolactam, undecalactam, and dodecalactam. One type of these may be used alone, or at least two types thereof may be used in combination.

Although the ω-aminocarboxylic acid is not limited to the following, examples thereof include a ω-amino fatty acid which is a compound obtained by ling-opening compound of lactam by water. As the lactam or ω-aminocarboxylic acid, at least two types of monomers may be used together and condensed.

Next, the polyamide resin obtained by condensation of diamine and dicarboxylic acid will be explained.

Although the diamine used as a monomer of the polyamide resin is not limited to the following, examples thereof include: linear aliphatic diamines such as hexamethylenediamine and pentamethylenediamine; branched aliphatic diamines such as 2-methylpentanediamine and 2-ethylhexamethylenediamine; aromatic diamines such as p-phenylenediamine and m-phenylenediamine; and alicyclic diamines such as cyclohexanediamine, cyclopentanediamine and cyclooctanediamine.

In contrast, although the dicarboxylic acid used as a monomer of the polyamide resin is not limited to the following, examples thereof include: aliphatic dicarboxylic acids such as adipic acid, pimelic acid and sebacic acid; aromatic dicarboxylic acids such as phthalic acid and isophthalic acid; and alicyclic dicarboxylic acids such as cyclohexanedicarboxylic acid.

Each one type of the above-mentioned diamines or dicarboxylic acids as monomers may be used alone, or each two or more types thereof may be used together to be condensed.

Although the component (A) is not limited to the following, at least one selected from the group consisting of polyamides and copolyamides may be used, for example.

The polyamide is preferably selected from the group consisting of polyamide 4, polyamide 6, polyamide 11, polyamide 12, polyamide 46, polyamide 66, polyamide 610, polyamide 612, polyamide 4T, polyamide 6T, polyamide 9T, polyamide 61 and polyamide MXD6, and more preferably selected from the group consisting of polyamide 6, polyamide 46, polyamide 66, polyamide 610, polyamide 612, polyamide 4T, polyamide 6T, polyamide 61 and polyamide MXD6.

The copolyamide is preferably a copolymer containing at least one selected from the group consisting of polyamide 6, polyamide 46, polyamide 66, polyamide 610, polyamide 612, polyamide 4T, polyamide 6T, polyamide 61 and polyamide MXD6 as a constituent.

Among the polyamide resins mentioned above, a polyamide resin having a melting point of 200° C. or higher is preferable as the component (A) from the viewpoint of improving the heat resistance of the resultant molded article. Although the preferable component (A) having such a characteristic is not limited to the following, at least one selected from the group consisting of polyamide 6, polyamide 46, polyamide 66, polyamide 610, polyamide 612, polyamide 4T, polyamide 6T, polyamide 61 and polyamide MXD6 and copolyamides containing at least two thereof as constituents is preferable.

The melting point of the component (A) is determined by a differential scanning calorimetry measurement method (DSC method) in accordance with JISK7121.

In addition, the ratio of carbon number/nitrogen number (C/N ratio) in the polymer chain of the component (A) preferably exceeds five from the viewpoint of heat aging resistance. The C/N ratio is more preferably more than five and 15 or less, and even more preferably more than five and 12 or less.

Although the copolyamide is not limited to the following, examples thereof include at least one copolymer selected from the group consisting of a copolymer of hexamethylene adipamide and hexamethylene terephthalamide; a copolymer of hexamethylene adipamide and hexamethylene isophthalamide; and a copolymer of hexamethylene terephthalamide and 2-methylpentanediamine terephthalamide.

In addition, the component (A) generally has an amino group or a carboxyl group as a terminal group. The concentrations of the terminal amino group and the terminal carboxyl group contained in component (A) relative to the total amount of the component (A) can be determined from integral values of characteristic signals corresponding to each terminal groups measured by 1H-NMR. The ratio of these concentrations can be calculated.

The concentration of terminal groups in the component (A) can be adjusted by a known method.

Although the method for adjusting the terminal groups is not limited to the following, examples thereof include a method in which a terminal modifier is used. Specifically, at least one selected from the group consisting of monoamines, diamines, monocarboxylic acids, and dicarboxylic acids is added so as to obtain a predetermined terminal concentration during polymerization of the component (A), thereby adjusting the concentration of terminal groups.

The timing of adding these components to a polymerization solvent is not particularly limited as long as original functions as terminal modifiers are exhibited, and the terminal modifier may be added when the above-mentioned materials of the polyamide resin are added to a polymerization solvent.

Although the monoamine as a terminal modifier is not limited to the following, examples thereof include: aliphatic monoamines such as methylamine, ethylamine, propylamine, butylamine, hexylamine, octylamine, decylamine, stearylamine, dimethylamine, diethylamine, dipropylamine, and dibutylamine; alicyclic monoamines such as cyclohexylamine and dicyclohexylamine; aromatic monoamines such as aniline, toluidine, diphenylamine and naphthylamine; and arbitrary mixtures thereof.

In particular, the monoamine is preferably at least one selected from the group consisting of butylamine, hexylamine, octylamine, decylamine, stearylamine, cyclohexylamine, and aniline from the viewpoints of reactivity, boiling point, stability of sealed terminal, and price.

Although the diamine as a terminal modifier is not limited to the following, examples thereof include: linear aliphatic diamines such as hexamethylenediamine and pentamethylenediamine; branched aliphatic diamines such as 2-methylpentanediamine and 2-ethylhexamethylenediamine; aromatic diamines such as p-phenylenediamine and m-phenylenediamine; alicyclic diamines such as cyclohexanediamine, cyclopentanediamine and cyclooctanediamine.

One type of these may be used alone, or at least two types thereof may be used in combination.

Although the monocarboxylic acid as a terminal modifier is not limited to the following, examples thereof include: aliphatic monocarboxylic acids such as acetic acid, propionic acid, butyric acid, valeric acid, caproic acid, caprylic acid, lauric acid, tridecylic acid, myristic acid, palmitic acid, stearic acid, pivalic acid and isobutyric acid; alicyclic monocarboxylic acids such as cyclohexanecarboxylic acid; and aromatic monocarboxylic acids such as benzoic acid, toluic acid, α-naphthalenecarboxylic acid, β-naphthalenecarboxylic acid, methylnaphthalenecarboxylic acid and phenylacetic acid.

One type of these monocarboxylic acids may be used alone, or at least two types thereof may be used in combination.

Although the dicarboxylic acid as a terminal modifier is not limited to the following, examples thereof include: aliphatic dicarboxylic acids such as malonic acid, dimethylmalonic acid, succinic acid, glutaric acid, adipic acid, 2-methyladipic acid, trimethyladipic acid, pimelic acid, 2,2-dimethylglutaric acid, 3,3-diethylsuccinic acid, azelaic acid, sebacic acid and suberic acid; alicyclic dicarboxylic acids such as 1,3-cyclopentanedicarboxylic acid and 1,4-cyclohexanedicarboxylic acid; and units derived from aromatic dicarboxylic acids such as isophthalic acid, 2,6-naphthalenedicarboxylic acid, 2,7-naphthalenedicarboxylic acid, 1,4-naphthalenedicarboxylic acid, 1,4-phenylenedioxydiacetic acid, 1,3-phenylenedioxydiacetic acid, diphenic acid, diphenylmethane-4,4′-dicarboxylic acid, diphenylsulfone-4,4′-dicarboxylic acid and 4,4′-biphenyldicarboxylic acid.

One type of these dicarboxylic acids may be used alone, or at least two types thereof may be used in combination.

The amount of the component (A) in the polyamide resin composition according to the present embodiment relative to 100 parts by mass of the polyamide resin composition is preferably 30 parts by mass to 90 parts by mass, more preferably 30 parts by mass to 80 parts by mass, and even more preferably 40 parts by mass to 70 parts by mass from the viewpoint of improving moldability and mechanical strength. In the present specification, when a numerical range is described using “to”, it means that the range includes the upper limit and the lower limit of the numerical range. In the above description, the phrase “30 parts by mass to 90 parts by mass” means “30 parts by mass or more and 90 parts by mass or less”.

The component (A) in the polyamide resin composition may be a combination of a main component polyamide (A-1) and at least one different polyamide (A-2) (different type of polyamide).

Here, the term “main component polyamide (A-1)” refers to a polyamide component that accounts for more than 10 parts by mass in 100 parts by mass of the component (A). In addition, the term “different polyamide (A-2)” refers to a polyamide component that accounts for 10 parts by mass or less in 100 parts by mass of the component (A).

The amount of the different polyamide (A-2) in 100 parts by mass of the component (A) is preferably 0.01 by mass to 10% by mass, more preferably 0.05 by mass to 8 parts by mass, even more preferably 0.1 parts by mass to 7 parts by mass, and most preferably 0.5 parts by mass to 5 parts by mass. When the amount of the different polyamide (A-2) in the component (A) is the upper limit or less, there is a tendency in which the Charpy impact strength and the retention ratio of the heat aging resistance are enhanced in a well-balanced manner. In contrast, when the addition amount of the different polyamide (A-2) in the component (A) is the lower limit or more, there is a tendency in which the retention ratio of the heat aging resistance is further enhanced.

A mixture of two types of the main component polyamide (A-1) with two types of the different polyamide (A-2) may be used as the component (A), for example.

At least one selected from the group consisting of the following polyamide and copolyamide serves as a polymer constituent of the different polyamide (A-2) in a similar manner to the polyamide and copolyamide mentioned above as constituents of the component (A).

Polyamide: At least one selected from the group consisting of polyamide 6, polyamide 46, polyamide 66, polyamide 610, polyamide 612, polyamide 4T, polyamide 6T, polyamide 61 and polyamide MXD6.

Copolyamide: Copolymer containing at least one selected from the group consisting of polyamide 6, polyamide 46, polyamide 66, polyamide 610, polyamide 612, polyamide 4T, polyamide 6T, polyamide 61 and polyamide MXD6 as a constituent.

Among them, polyamide 6, polyamide 46, polyamide 66, polyamide 610, polyamide 612, and polyamide 61 are preferable, polyamide 6, polyamide 66, polyamide 610, polyamide 612, and polyamide 61 are more preferable, and polyamide 6, polyamide 66, and polyamide 61 are even more preferable, from the viewpoint of external appearance and changes in color tone in the polyamide resin composition and a molded article thereof.

When a polyamide having a molecular weight different from that of the main component polyamide (A-1) is used as the different polyamide (A-2), the molecular weight of the different polyamide (A-2) is preferably lower than that of the main component polyamide (A-1).

The molecular weight of the different polyamide (A-2) is evaluated by the viscosity number measured using sulfuric acid having a mass fraction of 96% as a solvent in accordance with ISO 307. Specifically, 0.5% by mass of a polyamide resin solution is prepared at 25° C. using sulfuric acid having a concentration of 96% as a solvent, and the viscosity number of the solution is measured and evaluated.

The viscosity number (VN) of the different polyamide (A-2) is 70 mg/mL or more and 150 mg/mL or less, preferably 80 mg/mL or more and 150 mg/mL or less, more preferably 100 mg/mL or more and 150 mg/mL or less, and even more preferably 120 mg/mL or more and 145 mg/mL or less.

When the viscosity number is within the above-mentioned range, it is possible to provide a polyamide resin composition which exhibits an excellent fluidity during injection molding, as well as excellent mechanical strength and external appearance when made into a molded article.

### [Copper Compound (B)]

Although the component (B) is not limited to the following, examples thereof include copper halide, copper acetate, copper propionate, copper benzoate, copper adipate, copper terephthalate, copper isophthalate, copper salicylate, copper nicotinate, and copper stearate, and copper complexes coordinated with chelating agents such as ethylenediamine or ethylenediaminetetraacetic acid. One type of these copper compounds may be used alone or at least two types thereof may be used in combination. Among them, copper iodide, cuprous bromide, cupric bromide, cuprous chloride, and copper acetate are preferable, and copper iodide is more preferable, from the viewpoint of suppression of molecular weight decrease during melt kneading and the heat aging resistance

The amount of the component (B) as copper elements in the copper compound relative to 100 parts by mass of the component (A) is preferably 0.005 parts by mass to 0.3 parts by mass, more preferably 0.0130 parts by mass to 0.2 parts by mass, and even more preferably 0.05 parts by mass to 0.15 parts by mass. When the amount of copper elements relative to 100 parts by mass of the component (A) is within the above-mentioned range, there is a tendency in which the heat aging resistance of the polyamide resin composition is further improved and the precipitation of copper and metal corrosion are suppressed

### [Glass Fibers (C)]

Although the cross section of the component (C) (glass fibers) may be circular or flat (elliptical, cocoon-shaped, or the like), the cross section is preferably flat from the viewpoint of low warpage.

When the cross section of the component (C) is circular, the number average fiber diameter of the component (C) is preferably 3 μm or more and 30 μm or less, more preferably 9 μm or more and 20 μm or less, and even more preferably 12 μm or more and 19 μm, from the viewpoint of mechanical strength and external appearance.

When the cross section of the component (C) is flat, the average short diameter of the glass fibers is preferably 3 μm or more and 15 μm or less, more preferably 4 μm or more and 10 μm or less, and even more preferably 5 μm or more and 9 μm or less, from the viewpoint of mechanical strength, external appearance, and low warpage.

Regardless of whether the cross section of component (C) is circular or flat, the average cross-sectional area of the component (C) is preferably 50 μm² or more and 350 μm² or less, more preferably 100 μm² or more and 300 μm² or less, and even more preferably 120 μm² or more and 250 μm² or less, from the viewpoint of excellent mechanical strength and external appearance. The average cross-sectional area is a value obtained by taking a photograph of the cross section of the glass fibers (C) using a microscope, measuring the cross-sectional area of 50 randomly selected fibers, and averaging them.

The amount of boron elements in the component (C) relative to the total mass of the component (C) is 1% by mass or less, and more preferably 0.5% by mass or less, and it is even more preferable that no boron elements be contained.

When the amount of boron elements in the component (C) is within the above-mentioned range, the mechanical strength, rigidity, dimensional accuracy and external appearance of a molded article obtained from the polyamide resin composition tend to be more excellent.

The ratio (Mg/Si) of magnesium (Mg) elements and silicon (Si) elements contained in the component (C) is preferably 0.01 to 0.2, more preferably 0.01 to 0.1, even more preferably 0.01 to 0.05, and even more preferably 0.01 to 0.025. Alternatively, the ratio (Mg/Si) of magnesium (Mg) elements and silicon (Si) elements contained in the component (C) is preferably 0 to 0.025.

When the Mg/Si is within the above-mentioned range, there is a tendency in which the color tone change due to water absorption in a molded article is further suppressed, and a polyamide resin composition having a more excellent color tone change is obtained.

In the component (C), the amount of iron (Fe) elements relative to the total mass of the glass fibers (C) is preferably 0.01% by mass to 2.0% by mass, more preferably 0.05% by mass to 1.0% by mass, even more preferably 0.1% by mass to 0.75% by mass, even more preferably 0.15% by mass to 0.7% by mass, and most preferably 0.2% by mass to 0.6% by mass.

When the amount of iron elements in the component (C) is within the above-mentioned range, there is a tendency in which the color tone change due to water absorption in a molded article is further suppressed, and a polyamide resin composition having a more excellent color tone change is obtained.

In the component (C), the amount of sodium (Na) elements, which become alkali ions, relative to the total mass of the glass fibers (C) is preferably 0.1% by mass to 3.0% by mass, more preferably 0.1% by mass to 2.0% by mass, even more preferably 0.3% by mass to 1.8% by mass, even more preferably 0.4% by mass to 1.7% by mass, and most preferably 0.5% by mass to 1.6% by mass.

When the amount of sodium elements in the component (C) is within the above-mentioned range, the mechanical strength, rigidity, dimensional accuracy and external appearance of a molded article obtained from the polyamide resin composition tend to be more excellent.

The amount of the component (C) in the polyamide resin composition relative to 100 parts by mass of the polyamide resin is preferably 10 parts by mass to 250 parts by mass, more preferably 15 parts by mass to 150parts by mass, and even more preferably 15 parts by mass to 125parts by mass. Alternatively, the amount of the component (C) in the polyamide resin composition relative to 100 parts by mass of the polyamide resin is preferably 10 parts by mass to 60 parts by mass.

When the amount of the component (C) is within the above-mentioned range, the mechanical strength, rigidity, dimensional accuracy and color tone of a molded article obtained from the polyamide resin composition can be further improved.

The component (C) contains at least one selected from the group consisting of a surface treatment agent and a sizing agent. For example, at least one selected from the group consisting of a surface treatment agent and a sizing agent may be applied to the glass fibers. The processability, particularly the fibrillation property, is improved by including at least one selected from the group consisting of a surface treatment agent and a sizing agent in the component (C).

Although the surface treatment agent of the component (C) is not particularly limited, a silane coupling agent is preferably used, for example. Although the silane coupling agent is not particularly limited, examples thereof include: aminosilanes such as γ-aminopropyltriethoxysilane, γ-aminopropyltrimethoxysilane, and N-β-(aminoethyl)-γ-aminopropylmethyldimethoxysilane; mercaptosilanes such as γ-mercaptopropyltrimethoxysilane and γ-mercaptopropyltriethoxysilane; epoxysilanes; and vinylsilanes. Among them, aminosilanes are preferable. One type of the surface treatment agents may be used alone or at least two types thereof may be used in combination.

Although the sizing agent of the component (C) is not particularly limited, examples thereof include the following (a) to (f).
(a) Epoxy resin (sizing agent (a)).
(b) Polyurethane resin (sizing agent (b)).
(c) Homopolymer of acrylic acid (sizing agent (c)).
(d) Copolymer of acrylic acid and other copolymerizable monomer (sizing agent (d)).
(e) Salt of the homopolymer or the copolymer with a primary, secondary or tertiary amine (sizing agent (e)).
(f) Copolymer containing a carboxylic anhydride-containing unsaturated vinyl monomer and an unsaturated vinyl monomer as structural units (sizing agent (f)).

The unsaturated vinyl monomer in the sizing agent (f) does not include any carboxylic acid anhydride-containing unsaturated vinyl monomers.

One type of these sizing agents may be used alone or at least two types thereof may be used in combination.

Among them, the sizing agent (a), (b), or (f), or a combination thereof is preferable, and the sizing agent (b) or (f) or a combination thereof is more preferable, as the sizing agent of the component (C). The use of such a sizing agent tends to further improve the mechanical strength of the resin composition.

Although the carboxylic acid anhydride-containing unsaturated vinyl monomer that constitutes the sizing agent (f) is not particularly limited, examples thereof include maleic anhydride, itaconic anhydride, and citraconic anhydride. Among them, maleic anhydride is preferable.

Although the unsaturated vinyl monomer constituting the sizing agent (f) is not particularly limited, examples thereof include styrene, α-methylstyrene, ethylene, propylene, butadiene, isoprene, chloroprene, 2,3-dichlorlo butadiene, 1,3-pentadiene, cyclooctadiene, methyl methacrylate, methyl acrylate, ethyl acrylate, and ethyl methacrylate. Among them, styrene or butadiene is preferable.

Although the preferable sizing agent (f) is not particularly limited, examples thereof include a copolymer of maleic anhydride and butadiene, a copolymer of maleic anhydride and ethylene, a copolymer of maleic anhydride and styrene, and mixtures thereof.

The lower limit of the weight average molecular weight of the sizing agent (f) is preferably 2,000, and more preferably 5,000. The upper limit of the weight average molecular weight is preferably 1,000,000, and more preferably 500,000. When the weight average molecular weight is within the above-mentioned range, the fluidity of the polyamide resin composition tends to be further improved. In addition, the weight average molecular weight in the present specification can be measured by gel permeation chromatography (GPC).

Although the sizing agent (a) is not particularly limited, ones having at least two glycidyl groups are preferably used, for example. Among them, an epoxy resin obtained by reacting bisphenol and epihalohydrin is more preferable. The molar equivalent of epoxy groups in the sizing agent (a) is preferably 180 g/mole equivalent or more, and more preferably 450 g/mole equivalent or more and 1900 g/mole equivalent or less. When the epoxy equivalent is within the above-mentioned range, the bundling property of the glass fibers (B) tends to be further improved.

Although the sizing agent (b) is not particularly limited as long as it is generally used as a sizing agent in the component (C), examples thereof include ones synthesized from an isocyanate such as m-xylylene diisocyanate (XDI), 4,4′-methylenebis(cyclohexyl isocyanate) (HMDI), or isophorone diisocyanate (IPDI), and a polyester-based or polyether-based diol.

The weight average molecular weight of the sizing agent (c) is preferably 1,000 or more and 90,000 or less, more preferably 1,000 or more and 25,000 or less, and even more preferably 1,000 or more and 25,000 or less. The weight average molecular weight can be measured by a standard method using GPC.

Although the copolymerizable monomer that constitutes the sizing agent (d) is not particularly limited, examples thereof include monomers having at least one selected from the group consisting of a hydroxyl group and a carboxy group. Although such monomers having at least one selected from the group consisting of a hydroxyl group and a carboxy group are not particularly limited, examples thereof include at least one selected from the group consisting of acrylic acid, maleic acid, methacrylic acid, vinylacetic acid, crotonic acid, isocrotonic acid, fumaric acid, itaconic acid, citraconic acid, and mesaconic acid (provided that the case in which only an acrylic acid is selected is excluded). Among the above-mentioned monomers, at least one ester-based monomer is preferably included.

Although the primary, secondary, or tertiary amine that constitutes the sizing agent (e) is not particularly limited, examples thereof include triethylamine, triethanolamine, and glycine. The degree of neutralization is preferably 20% by mass or more and 90% by mass or less, more preferably 30% by mass or more and 80% by mass or less, and even more preferably 40% by mass or more and 60% by mass or less, from the viewpoint of improving the stability of a mixed solution with another concomitant agent (such as a silane coupling agent) and decrease in amine odor.

Although the weight average molecular weight of an acrylic acid polymer that constitutes the sizing agent (e) is not particularly limited, the weight average molecular weight is preferably 3,000 or more and 50,000 or less. When the weight average molecular weight is the above-mentioned lower limit or more, the bundling property of the glass fibers tends to be further improved. When the weight average molecular weight is the above-mentioned upper limit or less, the mechanical characteristics of the resin composition tend to be further improved.

A lubricant is preferably used when the component (C) is treated with at least one selected from the group consisting of a surface treatment agent and a sizing agent. Although the lubricant is not particularly limited, an arbitrary liquid or solid lubricant may be used appropriately depending on the purpose. Although such a lubricant is not particularly limited, examples thereof include: animal, plant, or mineral waxes such as carnauba wax and lanolin wax; fatty acid amides, fatty acid esters, and fatty acid ethers; and surfactants such as aromatic esters and aromatic ethers.

### (Method for Producing Glass Fibers (C))

The component (C) is obtained by coating (applying) at least one selected from the group consisting of the above-mentioned surface treatment agent and above-mentioned sizing agent to glass fibers using a conventionally-known method such as a roller applicator in a conventionally-known glass fiber producing step to obtain fiber strands, followed by drying the fiber strands to allow a continuous reaction to proceed.

Although the state of the component (C) is not particularly limited, the glass fiber strands may be used directly as rovings, or may be subjected to a cutting step to be used as chopped strands. The strands may be dried after the cutting step or before the cutting step.

The adhesion amount of at least one selected from the group consisting of the above-mentioned surface treatment agent and the above-mentioned sizing agent relative to 100% by mass of the component (C) as a solid fraction is preferably 0.2% by mass or more and 3% by mass or less, more preferably 0.2% by mass or more and 2% by mass or less, and even more preferably 0.3% by mass or more and 2% by mass or less.

When the adhesion amount of at least one selected from the group consisting of the surface treatment agent and the sizing agent is the above-mentioned lower limit or more, the bundling property of the glass fibers tends to be further improved. In contrast, when the adhesion amount of at least one selected from the group consisting of the surface treatment agent and the sizing agent is the above-mentioned upper limit or less, the thermal stability of the resin composition tends to be further improved.

One type of the component (C) may be used alone or at least two types thereof, the cross-sectional shape, average cross-sectional area, glass composition, surface treatment agent, sizing agent, or the like of which is different from each other, may be used in combination.

In addition, the component (C) may be used in the form of rovings, or chopped strands cut into lengths of 2 mm or more and 5 mm or less, for example.

The weight average fiber length of the component (C) is preferably 100 μm or more and 800 μm or less, more preferably 200 μm or more and 700 μm or less, and even more preferably 300 μm or more and 650 μm or less, from the viewpoint of mechanical strength and external appearance.

The weight average fiber length of the component (C) is determined, for example, by heating and incinerating pellets at a temperature higher than the decomposition temperature of the polyamide resin composition, photographing the remaining ash using a microscope, and measuring the length of glass fibers. The weight average fiber length is calculated from measured values obtained using the microscope in accordance with the following formula.

[Weight average fiber length]=[sum of squares of glass fiber length]/[total glass fiber length]

[Alkali Metal Halide and/or Alkaline Earth Metal Halide (D)]

Although the component (D) is not particularly limited, examples thereof include potassium iodide, potassium bromide, potassium chloride, sodium iodide, sodium chloride, calcium iodide, calcium bromide and calcium chloride, and mixtures thereof. Among them, the component (D) is preferably potassium iodide, potassium bromide, or a mixture thereof, and more preferably potassium iodide. When such a halide is used, there is a tendency in which the heat aging resistance of the polyamide resin composition is further improved, and metal corrosion is further suppressed. One type of the component (D) may be used alone, or at least two types thereof may be used in combination.

The amount of the component (D) in the polyamide resin composition relative to 100 parts by mass of the polyamide resin composition is preferably 0.05 parts by mass to 5 parts by mass, more preferably 0.05 parts by mass to 2 parts by mass, and even more preferably 0.05 parts by mass to 1 part by mass. When the amount of the halide is within the above-mentioned range, there is a tendency in which the suppression of the molecular weight decrease during melt kneading of the polyamide resin composition and the heat aging resistance are further improved, and the copper precipitation and metal corrosion are further suppressed.

The component (D) is preferably used together with the component (B) from the viewpoint of the heat aging resistance of the polyamide resin composition.

In addition, the molar ratio of the amount of the component (D) to the amount of the component (B) (component (D)/component (B)) is preferably 2/1 to 50/1. When the molar ratio is within the above-mentioned range, there is a tendency in which the molecular weight decrease during melt-kneading is further suppressed, and a polyamide resin composition having an improved heat resistance is obtained.

When the molar ratio of the component (D) to the component (B) is 2 or more, there is a tendency in which the copper precipitation and metal corrosion are further suppressed. In contrast, when the molar ratio of the component (D) to the component (B) is 50 or less, there is a tendency in which the corrosion of a screw of a molding machine can be further prevented without substantially impairing the mechanical properties such as heat resistance and toughness.

The halogen concentration (molar concentration) [X] in the polyamide resin composition relative to the component (A) is preferably 40 ppm or more and 9000 ppm or less.

When the copper halide is used as the component (B), the term “halogen” used herein means the sum of halogen derived from the copper halide (the component (B)) and halogen derived from the component (D).

The amount of the mixture of the component (B) and the component (D) in the polyamide resin composition relative to 100 parts by mass of the polyamide resin composition is preferably 0.01 parts by mass to 5 parts by mass, more preferably 0.05 parts by mass to 3 parts by mass, even more preferably 0.05 parts by mass to 2 parts by mass, still more preferably 0.1 parts by mass to 1.5 parts by mass, and most preferably 0.5 parts by mass to 1.3 parts by mass.

When the amount is within the above-mentioned range, the heat aging resistance of the polyamide resin composition tends to be further improved.

### [Coloring Agent (E)]

The polyamide resin composition may contain a coloring agent (E) (hereinafter, may be referred to as component (E)).

As the coloring agent (E), either or both of a pigment and an organic dye are preferable. Examples of the pigment include titanium oxide, zinc sulfide, zinc oxide, and iron oxide. Namely, the coloring agent (E) preferably contains at least one selected from the group consisting of titanium oxide, zinc sulfide, zinc oxide, iron oxide and an organic dye.

When the polyamide resin composition contains the component (E), the color tone of the component (A) as a chromatic color becomes favorable. Therefore, the external appearance of the polyamide resin composition can be improved.

The amount of the component (E) in the polyamide resin composition relative to 100 parts by mass of the polyamide resin composition is preferably 0.01 parts by mass to 5 parts by mass, more preferably 0.03 parts by mass to 3 parts by mass, and even more preferably 0.1 by mass to 1% by mass. When the amount is within in the above-mentioned range, there is a tendency in which the moldability of the polyamide resin composition can be further improved without impairing the mechanical strength of a molded article obtained from the polyamide resin composition.

The polyamide resin composition may contain an orange coloring agent such as “C.I. Pigment Orange 43” (pigment-based coloring agent) of CAS No. 4424-06-0 or “C. I. Solvent Orange 60” (dye-based coloring agent) of CAS No. 6925-69-5 as the component (E). The polyamide resin composition can be used as a material of a high voltage electrical part defined in Regulation No. 100 of the United Nations Economic Commission for Europe (UNECE) (uniform provision concerning the approval of vehicles with regard to specific requirements for the electric power train [2015/505]). In paragraph 2.17 of Regulation No. 100 mentioned above, it is described that the term “high voltage” is applied, in the case where the working effective voltage is the root mean square (rms) of more than 60 V and 1500 V or less (direct current) or more than 30 V and 1000 V or less (alternating current) in the classification of an electrical component or circuit.

The classification of the “high voltage” corresponds to the voltage class B in ISO 6469-3:2018 (“Electric automobile-Safety standards-Part 3: Electrical safety”). The section 5.2 thereof may be applied to electric parts in the voltage class B with appropriate hazard markings or the color “orange”.

The amount of the C. I. Pigment Orange 43 or C. I. Solvent Orange 60 in the polyamide resin composition relative to 100% by mass of the polyamide resin composition is preferably 0.01% by mass to 5% by mass, more preferably 0.03% by mass to 3% by mass, and even more preferably 0.1% by mass to 1% by mass. When the amount of the C. I. Pigment Orange 43 or C. I. Solvent Orange 60 in the polyamide resin composition is within the above-mentioned range, there is a tendency in which the orange color of the polyamide resin composition can be further improved without impairing the mechanical strength of a molded article obtained from the polyamide resin composition.

The pigment-based coloring agent is preferable in comparison with the dye-based coloring agent, because the pigment-based coloring agent has a heat resistance higher than that of the dye-based coloring agent, and is relatively resistant to fading. When the C. I. Pigment Orange 43 and the C. I. Solvent Orange 60 are compared, for example, from this point of view, the C.I. Pigment Orange 43 which is a pigment-based coloring agent is more unlikely faded and therefore is preferable.

### (Other Components)

In addition to the above-mentioned components (A) to (E), the polyamide resin composition may contain other components, as needed, within a range in which effects of the present invention are not impaired.

Although other components are not limited to the following, an antioxidant, ultraviolet absorber, heat stabilizer, photodegradation inhibitor, plasticizer, lubricant, release agent, nucleating agent, flame retardant, coloring agent, dye, or pigments may be added, or another thermoplastic resin may be mixed.

Here, since the properties of the above-mentioned other components greatly differ from each other, the preferable amount of each component varies. A person skilled in the art can determine a suitable amount of each other component described above.

When the polyamide resin composition contains 100 parts by mass of the component (A), 0.005 parts by mass to 0.3 parts by mass of the component (B), and 10 parts by mass to 60 parts by mass of component (C), the tensile strength per part by mass of the glass fibers is preferably 3.0 or more, and more preferably 3.0 or more and 5.0 or less, the tensile strength after heat aging being measured by a method described below. When the tensile strength per part by mass of the glass fibers is within the above-mentioned range, the heat aging resistance can be imparted to a molded article.

(Tensile Strength after Heat Aging)

A molded piece of a multi-purpose test piece (type A) produced using the polyamide resin composition by a method conforming to ISO 3167 is heat aged in a hot air circulating oven at 200° C. for 1,000 hours.

The test piece after heat aging is cooled at 23° C. for 24 hour or more, and then subjected to a tensile test at a tensile speed of 5 mm/min by a method conforming to ISO 527 to measure the tensile strength (MPa) after heat aging.

### [Method for Producing Polyamide Resin Composition]

Although the method for producing the polyamide resin composition of the present embodiment is not limited to the following, examples thereof include a method in which the component (B), the component (C), and, as needed, the component (D) are kneaded by a single-screw or multi-screw extruder in a state where the component (A) is melted.

More specifically, it is preferable to use a method in which the component (A), the component (B) and the component (D) are supplied from an upstream supply port, and then melted using a twin-screw extruder equipped with the upstream supply port and a downstream supply port, followed by supplying the glass fibers (C) from the downstream supply port to be melted and kneaded. When a roving of glass fibers or carbon fibers is used, the components can be made to be composite by a conventionally-known method.

The polyamide resin composition may also be obtained by direct addition or using a polyamide masterbatch as described below, in addition to the above-mentioned method.

Direct addition: Aspect in which the component (B), and, as needed, the component (D) are added during polymerization of the component (A), followed by melting and kneading the resulting polymer and the component (C).

Use of polyamide masterbatch: Aspect in which a polyamide and the component (B), and, as needed, the component (D) are melted and kneaded to obtain a composition (polyamide masterbatch), followed by further melting and kneading the composition with the component (A) and the component (C).

### (Polyamide Masterbatch)

Although the polyamide used to produce a polyamide masterbatch is not limited to the following, examples thereof include polyamide 6, polyamide 46, polyamide 66, polyamide 610, polyamide 612, polyamide 116, polyamide 11, polyamide 12, nylon TMHT, polyamides 61, 9T, and 6T, nylon PACM12, nylon dimethyl PACM12, polyamide MXD6, and polyamide 11T (H).

Among the polyamides described above, polyamide 6, polyamide 66, and polyamide 61 are preferable from the viewpoint of compatibility.

### (Organic Compound Having at Least One Amide Group)

An organic compound having at least one amide group (hereinafter, may be referred to as an “amide group-containing organic compound”) may be added and mixed during melt-kneading to produce the polyamide masterbatch. The amide group-containing organic compound is a compound having at least one amide group in a molecular chain thereof. Although the amide group-containing organic compound is not limited to the following, examples thereof include monoamides, substituted amides, methylol amides, and bisamides.

The monoamides are of the general formula: R—CONH₂ (wherein R is a saturated aliphatic, unsaturated aliphatic or aromatic group having 8 to 30 carbon atoms, or a group formed therefrom by partially substituting —H thereof with —OH). Although the monoamide used as an amide group-containing organic compound is not limited to the following, examples thereof include lauric acid amide, palmitic acid amide, stearic acid amide, behenic acid amide, hydroxystearic acid amide, oleic acid amide, erucic acid amide and ricinoleic acid amide.

The substituted amides are of the general formula: R¹—CONH—R² (wherein R¹ and R² are each independently a saturated aliphatic, unsaturated aliphatic or aromatic group having 8 to 30 carbon atoms, or a group formed therefrom by partially substituting —H thereof with —OH). Although the substituted amide used as the amide group-containing organic compound is not limited to the following, examples thereof include N-lauryl lauric acid amide, N-palmityl palmitic acid amide, N-stearyl stearic acid amide, N-oleyl oleic acid amide, N-stearyl oleic acid amide, N-oleyl stearic acid amide, N-stearyl erucic acid amide, N-oleyl palmitic acid amide, N-stearyl 12-hydroxystearic acid amide, and N-oleyl 12-hydroxystearic acid amide.

The methylol amides are of the general formula: R—CONHCH₂OH (wherein R is a saturated aliphatic, unsaturated aliphatic or aromatic group having 8 to 30 carbon atoms, or a group formed therefrom by partially substituting —H thereof with —OH). Although the methylol amide used as an amide group-containing organic compound is not limited to the following, examples thereof include methylol stearic acid amide, and methylol behenic acid amide.

The bisamides are of the general formula: (R—CONH)₂(CH₂)ₙ (wherein R is a saturated aliphatic, unsaturated aliphatic or aromatic group having 8 to 30 carbon atoms, or a group formed therefrom by partially substituting —H thereof with —OH, and n is 1 to 8). Although the bisamide used as an amide group-containing organic compound is not limited to the following, examples thereof include methylene bislauric acid amide, methylene bislauric acid amide, methylene bishydroxystearic acid amide, ethylene biscapric acid amide, ethylene bislauric acid amide, ethylene bisstearic acid amide, ethylene bisisostearic acid amide, ethylene bishydroxystearic acid amide, ethylene bisbehenic acid amide, hexamethylene bisstearic acid amide, hexamethylene bisbehenic acid amide, hexamethylene bishydroxystearic acid amide, butylene bishydroxystearic acid amide, N,N′-distearyl adipic acid amide, N,N′-distearyl sebacic acid amide, methylene bisoleic acid amide, ethylene bisoleic acid amide, ethylene biserucic acid amide, hexamethylene bisoleic acid amide, N,N′-dioleyl adipic acid amide, N,N′-dioleyl sebacic acid amide, m-xylylene bisstearic acid amide, and N,N′-distearyl isophthalic acid amide.

One type of the above-mentioned amide group-containing organic compounds may be used alone, or at least two types thereof may be mixed. Among the above-mentioned amide group-containing organic compounds, the bisamides are preferable from the viewpoint of further improving the dispersibility of copper compounds and halogen compounds.

The amount of the amide group-containing organic compound relative to 100 parts by mass of the polyamide that constitutes the polyamide masterbatch is preferably 0.1 parts by mass to 10 parts by mass, more preferably 0.5 parts by mass to 5.0 parts by mass, and even more preferably 1.0 part by mass to 4.0parts by mass. When the amount is within the above-mentioned range, the dispersibility of the component (B) and the component (D) which constitute the polyamide masterbatch in the polyamide resin is further improved, and the heat aging resistance of the polyamide resin composition and its molded article is sufficiently improved and the copper precipitation and corrosion are suppressed.

### (Method for Producing Polyamide Masterbatch)

A polyamide masterbatch is obtained by mixing the above-mentioned component (B), component (D), and amide group-containing organic compound with a polyamide.

Each component (B), component (D), and amide group-containing organic compound may be individually blended with the polyamide; at least two of the three components may be mixed in advance and then blended with the polyamide; at least two of the three components may be mixed and pulverized in advance and then blended with the polyamide; or at least two of the three components may be mixed, pulverized and tableted in advance and then blended with the polyamide.

A conventionally-known method may be applied as the method for mixing the component (B), the component (D) and the amide group-containing organic compound. For example, a tumbler, a Henschel mixer, a Proshare mixer, a Nauta mixer, a flow jet mixer, or the like may be used.

A conventionally-known method may be applied as the pulverizing method. For example, any of hammer mill, knife mill, ball mill, jaw crusher, cone crusher, roller mill, jet mill, and millstone may be used.

A conventionally-known method may be applied as the tableting method. For example, any of a compression granulation method, a tablet molding method, a dry extrusion granulation method, and a melt extrusion granulation method may be used.

The amount of the polyamide masterbatch in the polyamide resin composition relative to 100 parts by mass of the component (A) is preferably 0.01 parts by mass to 5 parts by mass, more preferably 0.3 parts by mass to 4 parts by mass, and even more preferably 0.5 parts by mass to 3 parts by mass.

### [Molded Article of Polyamide Resin Composition]

The molded article of the present embodiment contains the above-mentioned polyamide resin composition, and is obtained, for example, by subjecting the polyamide resin composition to an injection molding.

### [Use]

The molded article of the present embodiment can be favorably used as various molded articles and parts of automobiles, machinery industry, electrical/electronics, industrial materials, industrial materials, or daily/household goods.

### EXAMPLES

Hereinafter, the present invention will be described in detail with reference to specific examples and comparative examples, but the present invention is not limited to the following examples.

### [Evaluation Method]

Evaluation methods carried out in Examples and Comparative Examples will be described below. In each evaluation, pellets of polyamide resin compositions produced in Examples and Comparative Examples described later were used.

### <Viscosity Number (VN)>

The viscosity number was measured using the produced pellets in accordance with ISO307 (JIS-K6933). More specifically, the viscosity number was measured at 25° C. using a polyamide solution adjusted to 0.5% by mass with a sulfuric acid having a concentration of 96% as a solvent.

### <Weight Average Fiber Length of Glass Fibers>

The produced pellets were incinerated by heating in an electric furnace at 650° C. for two hours. 500 glass fibers were arbitrarily selected from the residue, and the fiber length was measured using an SEM photograph at a magnification of 1000 times. Then, the weight average fiber length was determined using the following formula.

[Weight average fiber length]=[sum of squares of glass fiber length]/[total glass fiber length]

### <Preparation of Test Piece: Molded Piece of Multi-Purpose Test Piece (Type A)>

A molded piece of a multi-purpose test piece (type A) was produced from the produced pellets by a method conforming to ISO 3167 using an injection molding machine (PS-40E: manufactured by NISSEI PLASTIC INDUSTRIAL CO., LTD.).

At that time, the injection and pressure holding time was set to 25 seconds, the cooling time was set to 15 seconds, the mold temperature was set to 80° C., and the molten resin temperature was set to 290° C.

### <Preparation of Test Piece: Tabular Plate Molded Piece>

A tabular plate molded piece was produced from the produced pellets, as follows. A tabular plate molded piece (having a size of 60 mm×90 mm and a thickness of 3 mm) was produced from pellets of the polyamide resin composition using an injection molding machine (PS-40E: manufactured by NISSEI PLASTIC INDUSTRIAL CO., LTD.) in which the cooling time was set to 25 seconds, the screw rotation speed was set to 150 rpm, the mold temperature was set to 80° C., the cylinder temperature was set to 290° C., and the injection pressure and the injection speed were appropriately adjusted such that the filling time became within a range of 1.0±0.1 seconds.

### <Physical Property Evaluation 1: Tensile Strength>

The multi-purpose test piece (type A) was subjected to a tensile test at a tensile speed of 5 mm/min by a method conforming to ISO 527 to measure the tensile strength (MPa).

<Physical Property Evaluation 2: Tensile Strength after Heat Aging>

The multi-purpose test piece (type A) was subjected to a heat aging in a hot air circulating oven at 200° C. for 1,000 hours.

The resultant was cooled at 23° C. for 24 hour or more, and then subjected to a tensile test at a tensile speed of 5 mm/min by a method conforming to ISO 527 to measure the tensile strength (MPa) after heat aging for 1,000 hours.

The retention ratio (%) of the tensile strength after heat aging relative to the tensile strength measured in the above-mentioned <physical property evaluation 1: tensile strength> was calculated.

<Physical Property Evaluation 3: Tensile Strength of Test Piece after Heat Aging Per Part by Mass of Glass Fibers>

A value was obtained by dividing the tensile strength determined in the above-mentioned <physical property evaluation 2: tensile strength after heat aging> by the amount of glass fibers (parts by mass).

### <Physical Property Evaluation 4: Bending Strength>

A test piece having a size of 80 mm×10 mm×4 mm was prepared by cutting the multipurpose test piece (type A). Next, the prepared test piece was subjected to a bending strength test at a test speed of 2 mm/min in accordance with ISO178 to measure the bending strength (MPa).

### <Physical Property Evaluation 5: Notched Charpy Impact Strength>

A notched test piece having a size of 80 mm×10 mm×4 mm was prepared by cutting the multipurpose test piece (type A). The notched Charpy impact strength (KJ/m²) was measured using the test piece in accordance with the ISO179 standard.

### <Physical Property Evaluation 6: Color Tone Change>

The tabular plate molded piece was left in a constant temperature and humidity room at a room temperature of 23° C. and a humidity of 50% for 50 hours and then the following measurement items were measured at the central portion of the molded piece in accordance with JIS-Z 8781 using a colorimeter (manufactured by NIPPON DENSHOKU INDUSTRIES Co., Ltd., ZE-2000).

Measurement items: L* (luminance), a* (redness), and b* (yellowness)

Then, the tabular plate molded piece was dried in a nitrogen atmosphere at 100° C. for 24 hours or 72 hours, and then the above-mentioned measurement items were measured at the central portion of the molded piece using the colorimeter in the same manner as before drying.

The color difference (ΔE*) from the color tone determined based on the following formula using the obtained measurement results was determined as the color tone change. It was judged that the smaller the ΔE* of the measured value, the smaller the change in color tone depending on the change in the moisture amount, and the better the distinguishability.

$$Δ {E}^{*} = √ \{ {( {LS}^{*} - {LB}^{*} )}^{2} + {( {aS}^{*} - {aB}^{*} )}^{2} + {( {bS}^{*} - {bB}^{*} )}^{2} \}$$

(LS*, aS*, bS*: L*, a*, b* of the molded piece after being left in the constant temperature and humidity room for 50 hours.

LB*, aB*, bB*: L*, a*, b* of the molded piece after drying for 24 hours or 72 hours in a nitrogen atmosphere.)

### <Physical Property Evaluation 7: Fading Change>

The tabular plate molded piece was allowed to absorb water for 300 hours in a constant temperature and humidity bath under an environment of 80° C. and 90%. The color difference (ΔE*) from the color tone before water absorption was taken as the fading change. It was judged that the smaller the color difference ΔE*, the more suppressed the fading deterioration.

### [Preparation of Materials]

### (Component (A): Main Component Polyamide and Different Polyamide)

### (PA-1) Polyamide 66

VN (sulfuric acid): 127 ml/g, terminal amino groups: 44 mmol/kg, and terminal carboxylic acid groups: 75 mmol/kg.

### (PA-2) Polyamide 66/61

VN (sulfuric acid): 117 ml/g, terminal amino groups: 47 mmol/kg, and terminal carboxylic acid groups: 132 mmol/kg.

### (PA-3) Polyamide 61

VN (sulfuric acid): 62 ml/g, terminal amino groups: 58 mmol/kg, and terminal carboxylic acid groups: 212 mmol/kg.

### (PA-4) Polyamide 610

VN (sulfuric acid): 117 ml/g, terminal amino groups: 42 mmol/kg, and terminal carboxylic acid groups: 65 mmol/kg.

### (PA-5) Polyamide 612

VN (sulfuric acid): 117 ml/g, terminal amino groups: 38 mmol/kg, and terminal carboxylic acid groups: 96 mmol/kg.

### (PA-6) Polyamide 6

VN (sulfuric acid): 112 ml/g, terminal amino groups: 41 mmol/kg, and terminal carboxylic acid groups: 78 mmol/kg.

### (PA-7) Polyamide 66

VN (sulfuric acid): 112 ml/g, terminal amino groups: 38 mmol/kg, and terminal carboxylic acid groups: 90 mmol/kg.

### (PA-8) Polyamide 66

VN (sulfuric acid): 124 ml/g, terminal amino groups: 46 mmol/kg, and terminal carboxylic acid groups: 78 mmol/kg.

### (Component (B) and Component (D))

Component (B): copper iodide (manufactured by Wako Pure Chemical Corporation, hereinafter, abbreviated as Cul)

Component (D): potassium iodide (manufactured by Wako Pure Chemical Corporation, hereinafter, abbreviated as KI)

Component (B): Component (D)=1:5 (mass ratio) in a mixture

### (Component (C): Glass Fibers)

### (GF-1) Product Name: ECS 10-03-568H (Manufactured by JUSHI GROUP Co., Ltd.)

Boron elements: 0.0% by mass, ratio of Mg/Si: 0.02, Fe elements: 0.34% by mass, and Na elements: 1.03% by mass.

### (GF-2) Product Name: ECS 301HP-3-H (Manufactured by Chongqing Polycomp International Corp)

Boron elements: 0.0% by mass, ratio of Mg/Si: 0.07, Fe elements: 0.50% by mass, and Na elements: 1.5% by mass.

### (GF-3) Product Name: HP-3610 (Manufactured by Nippon Electric Glass Co., Ltd.)

Boron elements: 0.0% by mass, ratio of Mg/Si: 0.17, Fe elements: 0.56% by mass, and Na elements: 0.56% by mass.

### (GF-4) Product Name: ECS 03T-275H (Manufactured by Nippon Electric Glass Co., Ltd.)

Boron elements: 2.0% by mass, ratio of Mg/Si: 0.03, Fe elements: 0.17% by mass, and Na elements: 1.8% by mass

### (GF-5) Product Name: CS 983-10P (Manufactured by Owens Corning)

Boron elements: 0.0%, ratio of Mg/Si: 0.00, Fe elements: 0.30% by mass, and Na elements: 1.34% by mass.

### (Component (E): Coloring Agent)

### (E-1) Product Name: Pigment Orange 43 (Manufactured by Clariant Chemicals, Pigment-Based Coloring Agent)

### (E-2) Product Name: C. I. Solvent Orange 60 (Manufactured by LANXESS, Dye-Based Coloring Agent)

### [Examples 1 to 17 and 20 to 25] [Comparative Example 1 to 12]

A twin-screw extruder [ZSK-26MC: manufactured by Coperion (Germany)] having a L/D (the cylinder length of the extruder/the cylinder diameter of the extruder) of 48 (number of barrels: 12), the twin-screw extruder being equipped with an upstream feed port in the first barrel from the upstream side of the extruder and a downstream feed port in the ninth barrel therefrom, was used.

In the twin-screw extruder, the temperature from the upstream feed port to a die was set at 290° C., the screw rotation speed was set at 250 rpm, and the discharge rate was set at 25 kg/hour.

Under such conditions, the main component polyamide (A-1) (PA-1, PA-2, PA-3, PA-4, PA-5, or PA-6), the mixture of the component (B) and the component (D), and the different polyamide (A-2) (PA-3, PA-4, PA-5, or PA-6) were supplied from the upstream feed port, respectively, and the component (C) (GF-1, GF-2, GF-3, GF-4 or GF-5) was supplied from the downstream feed port, at each ratio described in the following Tables 1 to 8.

Then, these were melted and kneaded to produce pellets of polyamide resin compositions of Examples 1 to 17 and 20 to 25 and Comparative Examples 1 to 12. In the following tables, the term “normal” in the cells indicated as kneading strength means that the temperature of the processed resin was less than 355° C. during extrusion rotation, and the term “strong kneading” means that the temperature of the processed resin was 355° C. or more during extrusion rotation.

The weight average fiber length of the component (C) was determined by the above-mentioned method using the obtained polyamide resin compositions (pellets).

TABLE 1

| | | | Exam- | Exam- | Exam- | Exam- | Exam- |
|---|---|---|---|---|---|---|---|
| | | | ple 1 | ple 2 | ple 3 | ple 4 | ple 5 |
| Main | PA-1 | parts by | 100 | 100 | 100 | 100 | 100 |
| component | | mass | | | | | |
| polyamide | | | | | | | |
| (A-1) | | | | | | | |
| Copper | CuI | | 0.15 | 0.16 | 0.17 | 0.17 | 0.19 |
| compound | | | | | | | |
| (B) | | | | | | | |
| Halogen | KI | | 0.76 | 0.80 | 0.83 | 0.83 | 0.93 |
| compound | | | | | | | |
| (D) | | | | | | | |
| Component (D)/ | | ratio | 5.00 | 5.00 | 5.00 | 5.00 | 5.00 |
| Component (B) | | | | | | | |
| Glass fibers | GF-1 | parts by | 17.8 | 33.7 | 54.3 | 54.3 | 101.0 |
| (C) | GF-2 | mass | | | | | |
| | GF-3 | | | | | | |
| | GF-4 | | | | | | |
| | GF-5 | | | | | | |
| Production method: kneading | | | Normal | Normal | Normal | Strong | Normal |
| strength | | | | | | kneading | |
| Production method: Q/N | | | 2.00 | 2.00 | 2.00 | 1.22 | 2.00 |
| Temperature of | | ° C. | 320 | 333 | 333 | 360 | 355 |
| processed resin | | | | | | | |
| Glass Fibers | Amount of Bi | % by | 0 | 0 | 0 | 0 | 0 |
| (C) | elements | mass | | | | | |
| | Mg/Si | ratio | 0.02 | 0.02 | 0.02 | 0.02 | 0.02 |
| | Amount of Fe | % by | 0.34 | 0.34 | 0.34 | 0.34 | 0.34 |
| | elements | mass | | | | | |
| | Amount of Na | | 1.03 | 1.03 | 1.03 | 1.03 | 1.03 |
| | elements | | | | | | |
| | Weight | μm | 633 | 559 | 487 | 430 | 425 |
| | average | | | | | | |
| | fiber length | | | | | | |

TABLE 2

| | | | Exam- | Exam- | Exam- | Exam- |
|---|---|---|---|---|---|---|
| | | | ple 6 | ple 7 | ple 8 | ple 20 |
| Main | PA-1 | parts | 100 | 100 | 100 | 100 |
| component | | by | | | | |
| polyamide | | mass | | | | |
| (A-1) | | | | | | |
| Copper | CuI | | 0.14 | 0.17 | 0.17 | 0.14 |
| compound | | | | | | |
| (B) | | | | | | |
| Halogen | KI | | 0.71 | 0.83 | 0.83 | 0.71 |
| compound | | | | | | |
| (D) | | | | | | |
| Component (D)/ | | ratio | 5.00 | 5.00 | 5.00 | 5.00 |
| Component (B) | | | | | | |
| Glass fibers | GF-1 | parts | | | | |
| (C) | GF-2 | by | 43.3 | | | |
| | GF-3 | mass | | 54.3 | | |
| | GF-4 | | | | 54.3 | |
| | GF-5 | | | | | 43.3 |
| Production method: kneading | | | Normal | Normal | Normal | Normal |
| strength | | | | | | |
| Production method: Q/N | | | 2.00 | 2.00 | 2.00 | 2.00 |
| Temperature of | | ° C. | 332 | 335 | 335 | 333 |
| processed resin | | | | | | |
| Glass Fibers | Amount of | % by | 0 | 0 | 0 | 0 |
| (C) | Bi elements | mass | | | | |
| | Mg/Si | ratio | 0.02 | 0.07 | 0.17 | 0.00 |
| | Amount of | % by | 0.34 | 0.50 | 0.56 | 0.30 |
| | Fe elements | mass | | | | |
| | Amount of | | 1.03 | 1.50 | 0.56 | 1.34 |
| | Na elements | | | | | |
| | Weight | μm | 520 | 463 | 456 | 462 |
| | average | | | | | |
| | fiber length | | | | | |

TABLE 3

| | | | Exam- | Exam- | Exam- | Exam- | Exam- |
|---|---|---|---|---|---|---|---|
| | | | ple 9 | ple 10 | ple 11 | ple 12 | ple 13 |
| Main | PA-1 | parts by | 99.8 | 99.5 | 97.0 | 95.0 | 95.0 |
| component | | mass | | | | | |
| polyamide | | | | | | | |
| (A-1) | | | | | | | |
| Different | PA-3 | | | | | | 5.0 |
| Polyamide | PA-4 | | | | | | |
| (A-2) | PA-5 | | | | | | |
| | PA-6 | | 0.2 | 0.5 | 3.0 | 5.0 | |
| Copper | CuI | | 0.17 | 0.17 | 0.17 | 0.17 | 0.17 |
| compound (B) | | | | | | | |
| Halogen | KI | | 0.83 | 0.83 | 0.83 | 0.83 | 0.83 |
| compound (D) | | | | | | | |
| Component (D)/ | | ratio | 5.00 | 5.00 | 5.00 | 5.00 | 5.00 |
| Component (B) | | | | | | | |
| Glass fibers | GF-1 | parts by | 54.3 | 54.3 | 54.3 | 54.3 | 54.3 |
| (C) | GF-2 | mass | | | | | |
| | GF-3 | | | | | | |
| | GF-4 | | | | | | |
| | GF-5 | | | | | | |
| Production method: kneading | | | Normal | Normal | Normal | Normal | Normal |
| strength | | | | | | | |
| Production method: Q/N | | | 2.00 | 2.00 | 2.00 | 2.00 | 2.00 |
| Temperature of | | ° C. | 332 | 330 | 329 | 326 | 328 |
| processed resin | | | | | | | |
| Glass fibers | Amount of Bi | % by | 0 | 0 | 0 | 0 | 0 |
| (C) | elements | mass | | | | | |
| | Mg/Si | ratio | 0.02 | 0.02 | 0.02 | 0.02 | 0.02 |
| | Amount of Fe | % by | 0.34 | 0.34 | 0.34 | 0.34 | 0.34 |
| | elements | mass | | | | | |
| | Amount of Na | | 1.03 | 1.03 | 1.03 | 1.03 | 1.03 |
| | elements | | | | | | |
| | Weight | μm | 486 | 494 | 502 | 520 | 486 |
| | average | | | | | | |
| | fiber length | | | | | | |

TABLE 4

| | | | Exam- | Exam- | Exam- | Exam- |
|---|---|---|---|---|---|---|
| | | | ple 14 | ple 15 | ple 16 | ple 17 |
| Main | PA-1 | parts | 97.0 | 95.0 | 97.0 | 95.0 |
| component | | by | | | | |
| polyamide | | mass | | | | |
| (A-1) | | | | | | |
| Different | PA-3 | | | | | |
| Polyamide | PA-4 | | 3.0 | 5.0 | | |
| (A-2) | PA-5 | | | | 3.0 | 5.0 |
| | PA-6 | | | | | |
| Copper | CuI | | 0.17 | 0.17 | 0.17 | 0.17 |
| compound | | | | | | |
| (B) | | | | | | |
| Halogen | KI | | 0.83 | 0.83 | 0.83 | 0.83 |
| compound | | | | | | |
| (D) | | | | | | |
| Component (D)/ | | ratio | 5.00 | 5.00 | 5.00 | 5.00 |
| Component (B) | | | | | | |
| Glass fibers | GF-1 | parts | 54.3 | 54.3 | 54.3 | 54.3 |
| (C) | GF-2 | by | | | | |
| | GF-3 | mass | | | | |
| | GF-4 | | | | | |
| | GF-5 | | | | | |
| Production method: kneading | | | Normal | Normal | Normal | Normal |
| strength | | | | | | |
| Production method: Q/N | | | 2.00 | 2.00 | 2.00 | 2.00 |
| Temperature of | | ° C. | 328 | 325 | 330 | 323 |
| processed resin | | | | | | |
| Glass fibers | Amount of | % by | 0 | 0 | 0 | 0 |
| (C) | Bi elements | mass | | | | |
| | Mg/Si | ratio | 0.02 | 0.02 | 0.02 | 0.02 |
| | Amount of | % by | 0.34 | 0.34 | 0.34 | 0.34 |
| | Fe elements | mass | | | | |
| | Amount of | | 1.03 | 1.03 | 1.03 | 1.03 |
| | Na elements | | | | | |
| | Weight | μm | 495 | 501 | 487 | 492 |
| | average | | | | | |
| | fiber length | | | | | |

TABLE 5

| | | | Exam- | Exam- | Exam- | Exam- | Exam- |
|---|---|---|---|---|---|---|---|
| | | | ple 21 | ple 22 | ple 23 | ple 24 | ple 25 |
| Main | PA-1 | parts by | | 70 | | 50 | 70 |
| component | PA-2 | mass | 100 | | | | |
| polyamide | PA-3 | | | 30 | | | |
| (A-1) | PA-4 | | | | 100 | | |
| | PA-5 | | | | | 50 | |
| | PA-6 | | | | | | 30 |
| Copper | CuI | | 0.19 | 0.19 | 0.17 | 0.17 | 0.17 |
| compound (B) | | | | | | | |
| Halogen | KI | | 0.93 | 0.93 | 0.83 | 0.83 | 0.83 |
| compound (D) | | | | | | | |
| Component (D)/ | | ratio | 5.00 | 5.00 | 5.00 | 5.00 | 5.00 |
| Component (B) | | | | | | | |
| Glass fibers | GF-1 | parts by | 101 | 101 | 54.3 | 54.3 | 54.3 |
| (C) | GF-2 | mass | | | | | |
| | GF-3 | | | | | | |
| | GF-4 | | | | | | |
| | GF-5 | | | | | | |
| Production method: kneading | | | Normal | Normal | Normal | Normal | Normal |
| strength | | | | | | | |
| Production method: Q/N | | | 2.00 | 2.00 | 2.00 | 2.00 | 2.00 |
| Temperature of | | ° C. | 338 | 336 | 326 | 328 | 327 |
| processed resin | | | | | | | |
| Glass fibers | Amount of Bi | % by | 0 | 0 | 0 | 0 | 0 |
| (C) | elements | mass | | | | | |
| | Mg/Si | ratio | 0.02 | 0.02 | 0.02 | 0.02 | 0.02 |
| | Amount of Fe | % by | 0.34 | 0.34 | 0.34 | 0.34 | 0.34 |
| | elements | mass | | | | | |
| | Amount of Na | | 1.03 | 1.03 | 1.03 | 1.03 | 1.03 |
| | elements | | | | | | |
| | Weight | μm | 379 | 385 | 486 | 481 | 483 |
| | average | | | | | | |
| | fiber length | | | | | | |

TABLE 6

| | | | Comparative | Comparative | Comparative |
|---|---|---|---|---|---|
| | | | example 1 | example 2 | example 3 |
| Main | PA-1 | parts | 100 | 100 | 100 |
| component | PA-2 | by mass | | | |
| polyamide | PA-3 | | | | |
| (A-1) | PA-4 | | | | |
| | PA-5 | | | | |
| | PA-6 | | | | |
| Copper | CuI | | 0.15 | 0.16 | 0.17 |
| compound (B) | | | | | |
| Halogen | KI | | 0.76 | 0.80 | 0.83 |
| compound (D) | | | | | |
| Component | | ratio | 5.00 | 5.00 | 5.00 |
| (D)/Component (B) | | | | | |
| Glass | GF-1 | parts | | | |
| fibers | GF-2 | by mass | | | |
| (C) | GF-3 | | | | |
| | GF-4 | | 17.8 | 33.7 | 54.3 |
| | GF-5 | | | | |

| Production method: | | | Normal | Normal | Normal |
|---|---|---|---|---|---|
| kneading strength | | | | | |
| Production method: Q/N | | | 2.00 | 2.00 | 1.22 |
| Temperature of | | ° C. | 320 | 333 | 360 |
| processed resin | | | | | |
| Glass | Amount of Bi | % by | 2 | 2 | 2 |
| fibers | elements | mass | | | |
| (C) | Mg/Si | ratio | 0.03 | 0.03 | 0.03 |
| | Amount of Fe | % by | 0.17 | 0.17 | 0.17 |
| | elements | mass | | | |
| | Amount of Na | | 1.80 | 1.80 | 1.80 |
| | elements | | | | |
| | Weight | μm | 545 | 473 | 355 |
| | average | | | | |
| | fiber length | | | | |

TABLE 7

| | | | Comparative | Comparative | Comparative |
|---|---|---|---|---|---|
| | | | example 5 | example 6 | example 7 |
| Main | PA-1 | parts | 100 | 100 | 100 |
| component | PA-2 | by mass | | | |
| polyamide | PA-3 | | | | |
| (A-1) | PA-4 | | | | |
| | PA-5 | | | | |
| | PA-6 | | | | |
| Copper | CuI | | 0.17 | 0.19 | |
| compound (B) | | | | | |
| Halogen | KI | | 0.83 | 0.93 | |
| compound (D) | | | | | |
| Component | | ratio | 5.00 | 5.00 | |
| (D)/Component (B) | | | | | |
| Glass | GF-1 | parts | | | 54.3 |
| fibers | GF-2 | by mass | | | |
| (C) | GF-3 | | | | |
| | GF-4 | | 54.3 | 101.0 | |
| | GF-5 | | | | |

| Production method: | | | Normal | Normal | Normal |
|---|---|---|---|---|---|
| kneading strength | | | | | |
| Production method: Q/N | | | 2.00 | 2.00 | 1.22 |
| Temperature of | | ° C. | 328 | 350 | 335 |
| processed resin | | | | | |
| Glass | Amount of Bi | % by | 2 | 2 | 0 |
| fibers | elements | mass | | | |
| (C) | Mg/Si | ratio | 0.03 | 0.03 | 0.03 |
| | Amount of Fe | % by | 0.17 | 0.17 | 0.34 |
| | elements | mass | | | |
| | Amount of Na | | 1.80 | 1.80 | 1.03 |
| | elements | | | | |
| | Weight | μm | 410 | 380 | 490 |
| | average | | | | |
| | fiber length | | | | |

TABLE 8

| | | | Comparative | Comparative | Comparative | Comparative | Comparative |
|---|---|---|---|---|---|---|---|
| | | | example 8 | example 9 | example 10 | example 11 | example 12 |
| Main | PA-1 | parts | | 70 | | 50 | 70 |
| component | PA-2 | by | 100 | | | | |
| polyamide | PA-3 | mass | | 30 | | | |
| (A-1) | PA-4 | | | | 100 | | |
| | PA-5 | | | | | 50 | |
| | PA-6 | | | | | | 30 |
| Copper | CuI | | 0.19 | 0.19 | 0.17 | 0.17 | 0.17 |
| compound | | | | | | | |
| (B) | | | | | | | |
| Halogen | KI | | 0.93 | 0.93 | 0.83 | 0.83 | 0.83 |
| compound | | | | | | | |
| (D) | | | | | | | |
| Component (D)/ | | ratio | 5.00 | 5.00 | 5.00 | 5.00 | 5.00 |
| Component (B) | | | | | | | |
| Glass fibers | GF-1 | parts | | | | | |
| (C) | GF-2 | by | | | | | |
| | GF-3 | mass | | | | | |
| | GF-4 | | 101 | 101 | 54.3 | 54.3 | 54.3 |
| | GF-5 | | | | | | |
| Production method: | | | Normal | Normal | Normal | Normal | Normal |
| kneading strength | | | | | | | |
| Production method: Q/N | | | 2.00 | 2.00 | 2.00 | 2.00 | 2.00 |
| Temperature of | | ° C. | 340 | 338 | 325 | 329 | 329 |
| processed resin | | | | | | | |
| Glass fibers | Amount | % by | 2 | 2 | 2 | 2 | 2 |
| (C) | of Bi | mass | | | | | |
| | elements | | | | | | |
| | Mg/Si | ratio | 0.03 | 0.03 | 0.03 | 0.03 | 0.03 |
| | Amount | % by | 0.17 | 0.17 | 0.17 | 0.17 | 0.17 |
| | of Fe | mass | | | | | |
| | elements | | | | | | |
| | Amount | | 1.80 | 1.80 | 1.80 | 1.80 | 1.80 |
| | of Na | | | | | | |
| | elements | | | | | | |
| | Weight | μm | 381 | 398 | 475 | 477 | 473 |
| | average | | | | | | |
| | fiber | | | | | | |
| | length | | | | | | |

The tensile strength, tensile strength after heat aging, tensile strength after heat aging per part by mass of the glass fibers, bending strength, Charpy impact strength, and color tone change were evaluated by the above-mentioned methods using the obtained pellets.

Evaluation results are shown in the following Tables 9 to 16.

The larger the tensile strength before heat aging, the more excellent the mechanical strength (mechanical property).

The larger the tensile strength after heat aging and the larger the retention ratio, the more excellent the heat aging resistance.

The larger the bending strength, the more excellent the rigidity.

The larger the Charpy impact strength, the more excellent the toughness (mechanical property).

The smaller the color difference ΔE* in the color tone change, the smaller the color tone change depending on the change in the moisture amount and the more excellent the distinguishability thereof.

TABLE 9

| | | | Exam- | Exam- | Exam- | Exam- | Exam- |
|---|---|---|---|---|---|---|---|
| | | | ple 1 | ple 2 | ple 3 | ple 4 | ple 5 |
| Heat aging | Tensile | MPa | 132 | 197 | 217 | 215 | 265 |
| resistance | strength (a) | | | | | | |
| | (before heat | | | | | | |
| | aging) | | | | | | |
| | Tensile | MPa | 70 | 99 | 112 | 115 | 151 |
| | strength (b) | | | | | | |
| | (after heat | | | | | | |
| | aging) | | | | | | |
| | Retention | % | 53.0 | 50.3 | 51.6 | 53.5 | 57.0 |
| | ratio | | | | | | |
| | ((b)/(a)) | | | | | | |
| (b)/amount of glass | | MPa | 4.67 | 3.96 | 3.20 | 3.29 | 3.02 |
| fibers | | | | | | | |
| Mechanical | Bending | MPa | 245 | 297 | 322 | 321 | 400 |
| properties | strength | | | | | | |
| | Charpy | KJ/m² | 6.2 | 10.9 | 15.3 | 13.9 | 19.8 |
| | impact | | | | | | |
| | strength | | | | | | |
| Color tone | Before and | ΔL* | −0.49 | 0.61 | −0.80 | −0.19 | 0.31 |
| | after drying | Δa* | 0.72 | 0.22 | −0.71 | −0.49 | 1.43 |
| | in nitrogen | Δb* | −0.25 | −0.81 | −0.19 | −1.00 | −0.05 |
| | atmosphere | ΔE* | 0.9 | 1.0 | 1.1 | 1.1 | 1.5 |
| | 100° C. × 24 hr | | | | | | |
| | Before and | ΔL* | 1.19 | 1.53 | −0.17 | 0.62 | 0.71 |
| | after drying | Δa* | 1.85 | 1.74 | 1.65 | 1.42 | 2.01 |
| | in nitrogen | Δb* | 3.07 | 3.24 | 4.32 | 4.92 | 4.92 |
| | atmosphere | ΔE* | 3.8 | 4.0 | 4.6 | 5.2 | 5.4 |
| | 100° C. × 72 hr | | | | | | |

TABLE 10

| | | | Exam- | Exam- | Exam- | Exam- |
|---|---|---|---|---|---|---|
| | | | ple 6 | ple 7 | ple 8 | ple 20 |
| Heat aging | Tensile | MPa | 200 | 208 | 205 | 190 |
| resistance | strength (a) | | | | | |
| | (before heat | | | | | |
| | aging) | | | | | |
| | Tensile | MPa | 115 | 110 | 109 | 98 |
| | strength (b) | | | | | |
| | (after heat | | | | | |
| | aging) | | | | | |
| | Retention | % | 57.5 | 52.9 | 53.2 | 51.6 |
| | ratio | | | | | |
| | ((b)/(a)) | | | | | |
| (b)/amount of glass | | MPa | 3.83 | 3.14 | 3.11 | 3.27 |
| fibers | | | | | | |
| Mechanical | Bending | MPa | 305 | 316 | 312 | 290 |
| properties | strength | | | | | |
| | Charpy | KJ/m² | 13.3 | 14.0 | 13.3 | 13.0 |
| | impact | | | | | |
| | strength | | | | | |
| Color tone | Before and | ΔL* | 0.61 | 0.71 | 0.66 | 0.65 |
| | after drying | Δa* | 0.25 | 1.50 | 1.46 | 1.32 |
| | in nitrogen | Δb* | −0.81 | −0.03 | −0.50 | −0.58 |
| | atmosphere | ΔE* | 1.1 | 1.7 | 1.7 | 1.6 |
| | 100° C. × 24 hr | | | | | |
| | Before and | ΔL* | 1.42 | 2.52 | 2.52 | 2.65 |
| | after drying | Δa* | 1.90 | 2.06 | 2.30 | 1.90 |
| | in nitrogen | Δb* | 3.24 | 4.60 | 4.70 | 4.55 |
| | atmosphere | ΔE* | 4.0 | 5.6 | 5.8 | 5.6 |
| | 100° C. × 72 hr | | | | | |

TABLE 11

| | | | Exam- | Exam- | Exam- | Exam- | Exam- |
|---|---|---|---|---|---|---|---|
| | | | ple 9 | ple 10 | ple 11 | ple 12 | ple 13 |
| Heat aging | Tensile | MPa | 216 | 217 | 218 | 215 | 219 |
| resistance | strength (a) | | | | | | |
| | (before heat | | | | | | |
| | aging) | | | | | | |
| | Tensile | MPa | 112 | 119 | 120 | 129 | 122 |
| | strength (b) | | | | | | |
| | (after heat | | | | | | |
| | aging) | | | | | | |
| | Retention | % | 51.9 | 54.8 | 55.0 | 60.0 | 55.7 |
| | ratio | | | | | | |
| | ((b)/(a)) | | | | | | |
| (b)/amount of glass | | MPa | 3.20 | 3.40 | 3.43 | 3.69 | 3.49 |
| fibers | | | | | | | |
| Mechanical | Bending | MPa | 321 | 323 | 324 | 320 | 330 |
| properties | strength | | | | | | |
| | Charpy | KJ/m² | 15.2 | 15.5 | 15.8 | 15.3 | 15.7 |
| | impact | | | | | | |
| | strength | | | | | | |
| Color tone | Before and | ΔL* | −0.69 | −0.49 | 0.21 | 0.71 | −0.89 |
| | after drying | Δa* | 0.40 | 0.35 | 0.15 | 0.07 | −0.54 |
| | in nitrogen | Δb* | −1.23 | −1.08 | −0.93 | −0.68 | −0.68 |
| | atmosphere | ΔE* | 1.5 | 1.2 | 1.0 | 1.0 | 1.2 |
| | 100° C. × 24 hr | | | | | | |
| | Before and | ΔL* | 0.91 | 1.38 | 1.38 | 1.41 | 1.21 |
| | after drying | Δa* | 1.87 | 2.07 | 1.87 | 2.15 | 2.20 |
| | in nitrogen | Δb* | 4.17 | 3.70 | 3.80 | 4.22 | 4.42 |
| | atmosphere | ΔE* | 4.7 | 4.5 | 4.5 | 4.9 | 5.1 |
| | 100° C. × 72 hr | | | | | | |

TABLE 12

| | | | Exam- | Exam- | Exam- | Exam- |
|---|---|---|---|---|---|---|
| | | | ple 14 | ple 15 | ple 16 | ple 17 |
| Heat aging | Tensile | MPa | 219 | 217 | 216 | 218 |
| resistance | strength (a) | | | | | |
| | (before heat | | | | | |
| | aging) | | | | | |
| | Tensile | MPa | 121 | 116 | 121 | 123 |
| | strength (b) | | | | | |
| | (after heat | | | | | |
| | aging) | | | | | |
| | Retention | % | 55.3 | 53.5 | 56.0 | 56.4 |
| | ratio | | | | | |
| | ((b)/(a)) | | | | | |
| (b)/amount of glass | | MPa | 3.46 | 3.31 | 3.46 | 3.51 |
| fibers | | | | | | |
| Mechanical | Bending | MPa | 329 | 332 | 323 | 326 |
| properties | strength | | | | | |
| | Charpy | KJ/m² | 15.7 | 16.0 | 15.3 | 15.7 |
| | impact | | | | | |
| | strength | | | | | |
| Color tone | Before and | ΔL* | 0.91 | 1.41 | 0.16 | 0.34 |
| | after drying | Δa* | 0.27 | 0.47 | 0.47 | 0.62 |
| | in nitrogen | Δb* | 0.57 | 0.67 | 0.92 | 1.15 |
| | atmosphere | ΔE* | 1.1 | 1.6 | 1.0 | 1.3 |
| | 100° C. × 24 hr | | | | | |
| | Before and | ΔL* | 1.88 | 2.08 | 1.28 | 1.48 |
| | after drying | Δa* | 1.99 | 3.07 | 1.72 | 1.67 |
| | in nitrogen | Δb* | 3.76 | 3.67 | 3.79 | 4.17 |
| | atmosphere | ΔE* | 4.7 | 5.2 | 4.4 | 4.7 |
| | 100° C. × 72 hr | | | | | |

TABLE 13

| | | | Exam- | Exam- | Exam- | Exam- | Exam- |
|---|---|---|---|---|---|---|---|
| | | | ple 21 | ple 22 | ple 23 | ple 24 | ple 25 |
| Heat aging | Tensile | MPa | 275 | 280 | 187 | 205 | 190 |
| resistance | strength (a) | | | | | | |
| | (before heat | | | | | | |
| | aging) | | | | | | |
| | Tensile | MPa | 160 | 168 | 141 | 140 | 110 |
| | strength (b) | | | | | | |
| | (after heat | | | | | | |
| | aging) | | | | | | |
| | Retention | % | 58.2 | 60.0 | 75.4 | 68.3 | 57.9 |
| | ratio | | | | | | |
| | ((b)/(a)) | | | | | | |
| (b)/amount of glass | | MPa | 3.20 | 3.36 | 4.03 | 4.00 | 3.15 |
| fibers | | | | | | | |
| Mechanical | Bending | MPa | 375 | 400 | 286 | 304 | 280 |
| properties | strength | | | | | | |
| | Charpy | KJ/m² | 17.8 | 19.5 | 14.3 | 14.8 | 15.6 |
| | impact | | | | | | |
| | strength | | | | | | |
| Color tone | Before and | ΔL* | −0.76 | −0.96 | −0.76 | −0.36 | 0.54 |
| | after drying | Δa* | −0.30 | −0.50 | 0.70 | 1.00 | 0.80 |
| | in nitrogen | Δb* | −0.73 | −0.63 | −0.23 | −0.43 | −0.63 |
| | atmosphere | ΔE* | 1.1 | 1.2 | 1.1 | 1.1 | 1.2 |
| | 100° C. × 24 hr | | | | | | |
| | Before and | ΔL* | 1.21 | 0.91 | 0.51 | 0.61 | 1.01 |
| | after drying | Δa* | 2.45 | 2.55 | 1.45 | 1.35 | 1.15 |
| | in nitrogen | Δb* | 4.47 | 4.52 | 4.40 | 4.42 | 4.58 |
| | atmosphere | ΔE* | 5.2 | 5.3 | 4.7 | 4.7 | 4.8 |
| | 100° C. × 72 hr | | | | | | |

TABLE 14

| | | | Comparative | Comparative | Comparative |
|---|---|---|---|---|---|
| | | | example 1 | example 2 | example 3 |
| Heat aging | Tensile | MPa | 120 | 170 | 185 |
| resistance | strength (a) | | | | |
| | (before heat | | | | |
| | aging) | | | | |
| | Tensile | MPa | 44 | 73 | 85 |
| | strength (b) | | | | |
| | (after heat | | | | |
| | aging) | | | | |
| | Retention | % | 36.7 | 42.9 | 45.9 |
| | ratio | | | | |
| | ((b)/(a)) | | | | |
| (b)/amount of | | MPa | 2.93 | 2.92 | 2.43 |
| glass fibers | | | | | |
| Mechanical | Bending | MPa | 210 | 266 | 290 |
| properties | strength | | | | |
| | Charpy | KJ/m² | 5.4 | 7.3 | 9.9 |
| | impact | | | | |
| | strength | | | | |
| Color | Before and | ΔL* | −3.86 | −3.06 | −6.46 |
| tone | after drying | Δa* | 2.74 | 3.44 | 3.69 |
| | in nitrogen | Δb* | 8.61 | 8.81 | 10.78 |
| | atmosphere | ΔE* | 9.8 | 9.9 | 13.1 |
| | 100° C. × 24 hr | | | | |
| | Before and | ΔL* | −2.95 | −3.06 | −4.63 |
| | after drying | Δa* | 6.80 | 6.63 | 7.20 |
| | in nitrogen | Δb* | 8.00 | 9.50 | 10.89 |
| | atmosphere | ΔE* | 10.9 | 12.0 | 13.9 |
| | 100° C. × 72 hr | | | | |

TABLE 15

| | | | Comparative | Comparative | Comparative |
|---|---|---|---|---|---|
| | | | example 5 | example 6 | example 7 |
| Heat aging | Tensile | MPa | 200 | 224 | 211 |
| resistance | strength (a) | | | | |
| | (before heat | | | | |
| | aging) | | | | |
| | Tensile | MPa | 103 | 76 | 0 |
| | strength (b) | | | | |
| | (after heat | | | | |
| | aging) | | | | |
| | Retention | % | 51.5 | 33.9 | Could not |
| | ratio | | | | tested |
| | ((b)/(a)) | | | | |
| (b)/amount of | | MPa | 2.94 | 1.52 | 0.00 |
| glass fibers | | | | | |
| Mechanical | Bending | MPa | 307 | 342 | 320 |
| properties | strength | | | | |
| | Charpy | KJ/m² | 12.8 | 12.3 | 15.5 |
| | impact | | | | |
| | strength | | | | |
| Color | Before and | ΔL* | −3.46 | −3.46 | 0.34 |
| tone | after drying | Δa* | 5.29 | 5.79 | 0.70 |
| | in nitrogen | Δb* | 9.78 | 10.78 | −0.93 |
| | atmosphere | ΔE* | 11.6 | 12.7 | 1.2 |
| | 100° C. × 24 hr | | | | |
| | Before and | ΔL* | −3.06 | −3.01 | 2.12 |
| | after drying | Δa* | 7.28 | 6.72 | 0.24 |
| | in nitrogen | Δb* | 9.50 | 11.69 | 5.74 |
| | atmosphere | ΔE* | 12.4 | 13.8 | 6.1 |
| | 100° C. × 72 hr | | | | |

TABLE 16

| | | | Comparative | Comparative | Comparative | Comparative | Comparative |
|---|---|---|---|---|---|---|---|
| | | | example 8 | example 9 | example 10 | example 11 | example 12 |
| Heat aging | Tensile | MPa | 235 | 252 | 175 | 190 | 180 |
| resistance | strength (a) | | | | | | |
| | (before heat | | | | | | |
| | aging) | | | | | | |
| | Tensile | MPa | 114 | 124 | 92 | 94 | 86 |
| | strength (b) | | | | | | |
| | (after heat | | | | | | |
| | aging) | | | | | | |
| | Retention | % | 48.5 | 49.2 | 52.6 | 49.3 | 47.8 |
| | ratio | | | | | | |
| | ((b)/(a)) | | | | | | |
| (b)/amount of glass | | MPa | 2.28 | 2.48 | 2.63 | 2.68 | 2.46 |
| fibers | | | | | | | |
| Mechanical | Bending | MPa | 360 | 378 | 257 | 289 | 262 |
| properties | strength | | | | | | |
| | Charpy | KJ/m² | 13.2 | 17.7 | 11.5 | 13.2 | 13.8 |
| | impact | | | | | | |
| | strength | | | | | | |
| Color tone | Before and | ΔL* | −3.89 | −2.79 | −5.56 | −4.79 | −0.79 |
| | after drying | Δa* | 2.70 | 3.65 | 0.03 | 3.15 | 3.95 |
| | in nitrogen | Δb* | 8.67 | 9.67 | 7.58 | 7.67 | 8.47 |
| | atmosphere | ΔE* | 9.9 | 10.7 | 9.4 | 9.6 | 9.4 |
| | 100° C. × 24 hr | | | | | | |
| | Before and | ΔL* | −2.79 | −2.99 | −3.49 | −3.69 | −2.99 |
| | after drying | Δa* | 6.95 | 6.80 | 6.77 | 6.75 | 6.99 |
| | in nitrogen | Δb* | 9.65 | 9.77 | 9.56 | 9.82 | 9.79 |
| | atmosphere | ΔE* | 12.2 | 12.3 | 12.2 | 12.5 | 12.4 |
| | 100° C. × 72 hr | | | | | | |

As a result of the evaluation, the discoloration due to moisture of the test pieces prepared from the polyamide resin compositions of Examples 1 to 17 and 20 to 25 was suppressed while maintaining the mechanical properties and heat aging resistance in comparison with the test pieces prepared from the polyamide resin compositions of Comparative Examples 1 to 12.

### Examples 18 and 19

Pellets of polyamide resin compositions of Examples 18 and 19 were produced by the same way as that of Example 1, except that the main component polyamide (A-1) (PA-1), the mixture of the component (B) and the component (D), and the coloring agent (E) were supplied from the upstream feed port, respectively, and the component (C) was supplied from the downstream feed port at each ratio shown in the following Table 17.

TABLE 17

| | | | Example 18 | Example 19 |
|---|---|---|---|---|
| Main component | PA-1 | parts | 100.0 | 100.0 |
| polyamide (A-1) | | by mass | | |
| Copper | CuI | | 0.17 | 0.17 |
| compound (B) | | | | |
| Halogen | KI | | 0.83 | 0.83 |
| compound (D) | | | | |
| Component | | ratio | 5.00 | 5.00 |
| (D)/Component (B) | | | | |
| Glass fibers (C) | GF-1 | | 54.3 | 54.3 |
| Coloring agent (E) | E-1 | parts | 0.8 | |
| Orange | E-2 | by mass | | 0.8 |

| Production method: | | | Normal | Normal |
|---|---|---|---|---|
| kneading strength | | | | |
| Production method: Q/N | | | 2.00 | 2.00 |
| Temperature of | | ° C. | 332 | 332 |
| processed resin | | | | |
| Glass | Amount of Bi | % by | 0 | 0 |
| fibers | elements | mass | | |
| (C) | Mg/Si | ratio | 0.02 | 0.02 |
| | Amount of Fe | % by | 0.34 | 0.34 |
| | elements | mass | | |
| | Amount of Na | | 1.03 | 1.03 |
| | elements | | | |
| | Weight average | μm | 442 | 439 |
| | fiber length | | | |

The tensile strength, bending strength, Charpy impact strength and fading change were evaluated by the above-mentioned methods using the obtained pellets. Since the compositions in Examples 18 and 19 were produced by the same way as that in Example 3, except that the temperature of the processed resin differed slightly and the coloring agent was used, it was assumed that the heat aging resistance in Examples 18 and 19 exhibited a similar behavior and tendency to that in Example 3.

Evaluation results are shown in the following Table 18.

TABLE 18

| | | | Example 18 | Example 19 |
|---|---|---|---|---|
| Mechanical | Tensile strength (a) | MPa | 212 | 211 |
| properties | (before heat aging) | | | |
| | Bending strength | MPa | 320 | 320 |
| | Charpy impact | KJ/m² | 14.8 | 14.7 |
| | strength | | | |
| Fading | Constant | ΔL* | −2.50 | −5.67 |
| test | temperature and | Δa* | −2.33 | −3.75 |
| | humidity bath | Δb* | −2.62 | 7.60 |
| | 80° C. | ΔE* | 4.31 | 10.20 |
| | 90% × 300 h | | | |

As a result of the evaluation, it was confirmed that the change in color tone in Example 18 in which the pigment-based coloring agent was used was smaller (ΔE* was smaller) than that in Example 19 in which the dye-based coloring agent was used, and the discoloration in Example 18 could be suppressed in comparison with Example 19.

### INDUSTRIAL APPLICABILITY

The present invention makes it possible to provide a polyamide resin composition which can suppress the discoloration (fading) due to moisture while maintaining the mechanical properties and high heat aging resistance. In addition, a molded article which can suppress the discoloration due to moisture while maintaining the mechanical properties and high heat aging resistance can be provided by using such a polyamide resin composition as a material.

1. A polyamide resin composition comprising:
100 parts by mass of a polyamide resin (A);
0.005 parts by mass to 0.3 parts by mass of a copper compound (B); and
10 parts by mass to 250 parts by mass of glass fibers (C), wherein
an amount of boron elements in the glass fibers (C) relative to a total mass of the glass fibers (C) is 1% by mass or less.

2. The polyamide resin composition according to claim 1, wherein
the polyamide resin (A) is at least one selected from the group consisting of polyamides and copolyamides,
the polyamide is selected from the group consisting of polyamide 6, polyamide 46, polyamide 66, polyamide 610, polyamide 612, polyamide 4T, polyamide 6T, polyamide 6I and polyamide MXD6, and
the copolyamide is a copolymer comprising at least one selected from the group consisting of polyamide 6, polyamide 46, polyamide 66, polyamide 610, polyamide 612, polyamide 4T, polyamide 6T, polyamide 6I and polyamide MXD6 as a constituent.

3. The polyamide resin composition according to claim 2, wherein
the polyamide resin (A) comprises: a main component polyamide (A-1); and at least one different polyamide (A-2).

4. The polyamide resin composition according to claim 3, wherein a molecular weight of the different polyamide (A-2) is smaller than a molecular weight of the main component polyamide (A-1).

5. The polyamide resin composition according to claim 3, wherein
an amount of the different polyamide (A-2) relative to 100 parts by mass of the polyamide resin (A) is 0.01 parts by mass to 10 parts by mass.

6. The polyamide resin composition according to claim 1, further comprising at least one selected from the group consisting of an alkali metal halide and an alkaline earth metal halide (D), wherein a molar ratio of an amount of the halide (D) and an amount of the copper compound (B) is 2/1 to 50/1.

7. The polyamide resin composition according to claim 1, wherein a ratio (Mg/Si) of magnesium (Mg) elements and silicon (Si) elements in the glass fibers (C) is 0.01 to 0.2.

8. The polyamide resin composition according to claim 1, wherein an amount of iron elements in the glass fibers (C) relative to the total mass of the glass fibers (C) is 0.01% by mass to 2.0% by mass.

9. The polyamide resin composition according to claim 1, wherein the amount of sodium elements in the glass fibers (C) relative to the total mass of the glass fibers (C) is 0.1% by mass to 3.0% by mass.

10. The polyamide resin composition according to claim 1, further comprising 0.01 parts by mass to 5 parts by mass of a coloring agent (E) relative to 100 parts by mass of the polyamide resin composition.

11. The polyamide resin composition according to claim 10, wherein the coloring agent (E) comprises at least one selected from the group consisting of titanium oxide, zinc sulfide, zinc oxide, iron oxide and an organic dye.

12. The polyamide resin composition according to claim 11, wherein the coloring agent (E) comprises at least one orange coloring agent.

13. A molded article formed from a polyamide resin composition of claim 1.

14. A molded article formed from a polyamide resin composition of claim 11.

15. A molded article formed from a polyamide resin composition of claim 12.

16. The molded article according to claim 13, wherein the molded article is an automobile part.

17. The molded article according to claim 14, wherein the molded article is an automobile part.

18. A polyamide resin composition comprising:
100 parts by mass of a polyamide resin (A);
0.005 parts by mass to 0.3 parts by mass of a copper compound (B); and
10 parts by mass to 60 parts by mass of glass fibers (C), wherein
the polyamide resin composition has a tensile strength of 3.0 or more per part by mass of the glass fibers, the tensile strength being measured after heat aging by a method described below:
(tensile strength after heat aging)
a molded piece of a multi-purpose test piece (type A) produced using the polyamide resin composition by a method conforming to ISO 3167 is heat aged for 1,000 hours at 200° C. in a hot air circulating oven, and
the test piece after heat aging is cooled at 23° C. for 24 hour or more, and then subjected to a tensile test at a tensile speed of 5 mm/min by a method conforming to ISO 527 to measure the tensile strength after heat aging (MPa).

19. The molded article according to claim 15, wherein the molded article is an automobile part.
